(19) United States
(12) Patent Application Publication
(10) Pub. No.: US 2018/0064125 A1
(43) Pub. Date: Mar. 8, 2018

(54) INHIBITION OF PATHOGENIC GROWTH ON PLANT MATERIALS USING LACTIC ACID PRODUCING MICROORGANISMS

(71) Applicant: CHR. HANSEN A/S, HOERSHOLM (DK)

(72) Inventors: Douglas R. Ware, Chapel Hill, NC (US); Mindy M. Brashears, Wolfforth, TX (US)

(21) Appl. No.: 15/620,389

(22) Filed: Jun. 12, 2017

Related U.S. Application Data
(63) Continuation of application No. 13/318,264, filed on Apr. 23, 2012, now abandoned.
(60) Provisional application No. 61/173,907, filed on Apr. 29, 2009.

(51) Int. Cl. A23B 7/155; A01N 63/00; A01N 25/12; A01N 37/36

(52) U.S. Cl. CPC A23B 7/155; A23Y 2220/00; A01N 2300/00; A01N 25/12; A01N 37/36; A01N 63/00

(57) ABSTRACT

Improved compositions and methods are disclosed for improving food safety. More specifically, one or more lactic acid producing microorganisms are used for inhibiting pathogenic growth on plant materials before, during and/or after harvest. The disclosed methodology is particularly effective for leafy vegetables, such as spinach.

### RELATED APPLICATIONS

This application is a continuation of U.S. patent application Ser. No. 13/318,264, with a § 371(c) date of Apr. 23, 2012, which is a 35 U.S.C. § 371 filing of International Application No. PCT/US2010/033029, filed Apr. 29, 2010, which claims priority of U.S. Provisional Application No. 61/173,907 filed Apr. 29, 2009, the contents of each of these application are hereby incorporated into this application by reference in its entirety.

### FIELD OF THE INVENTION

The present disclosure relates to compositions and methods for improving food safety. More specifically, the disclosure relates to compositions and methods for inhibiting pathogenic growth on plant materials through the use of lactic acid producing microorganisms.

### BACKGROUND OF THE INVENTION

Food-contaminating pathogens pose health risks ranging from mild to life-threatening to humans and animals Bacteria and fungi are two of the most common pathogens found in contaminated vegetables and fruits. Examples of food sources that are prone to such contamination include plant materials such as leafy vegetables, certain fruits and products derived therefrom, meat, milk, and sewage-contaminated water.

Pathogens that are present in the soil, in water used for irrigation, in farm equipments or packaging equipments, may find their way onto plant materials. When humans consume the plant materials that have not been washed sufficiently to remove these pathogens, serious infections may result. This is a difficult problem to solve because contaminated plant materials may look and smell perfectly normal. Furthermore, the pathogenic organisms that cause disease are microscopic and are usually hard to detect.

Pathogens that cause disease in the intestinal tract are also known as enteropathogens. Examples of enteropathogenic bacteria, or enterobacteria, include Staphylococcus aureus, various strains of Escherichia coli (E. coli), and Salmonella spp. Whereas many of the hundreds of strains of E. coli are harmless and live in the intestines of animals, including humans, some strains, such as E. coli O157:H7, O111:H8, and O104:H21, produce large quantities of powerful shiga-like toxins that are closely related to or identical to the toxin produced by Shigella dysenteriae. These toxins may cause severe distress in the small intestine, often resulting in damage to the intestinal lining and resulting in extreme cases of diarrhea. E. coli O157:H7 can also cause acute hemorrhagic colitis, characterized by severe abdominal cramping and abdominal bleeding. In children, this can progress into the rare but fatal disorder called hemolytic uremic syndrome (“HUS”), characterized by renal failure and hemolytic anemia. In adults, it can progress into an ailment termed thrombotic thrombocytopenic purpura (“TTP”), which includes HUS plus fever and neurological symptoms and can have a mortality rate as high as fifty percent in the elderly.

Reduction of risk for illnesses due to food borne pathogens may be achieved by controlling various points of potential contamination, such as before, during, or after harvest or during processing. Contaminated irrigation or wash water, improperly treated manure, wild animals, human handling, and air contamination are a few of the most commonly recognized vectors for transmission of E. coli O157:H7 onto plant materials.

Seed decontamination and Good Agricultural Practices (GAP) are the only pre-harvest food safety intervention methods that have been reported. Effective methods for decontaminating seeds include chlorine compounds, ethanol, hydrogen peroxide, calcium EDTA, ozonate water, and other commercial disinfectants. Hot water treatment, irradiation, ozone gas, acidified sodium chlorite or quaternary ammonium salt, and other non-thermal approaches including pressurized carbon dioxide, ultraviolet radiation, ultrasound treatments, and magnetic resonance fields are potential seed treatments have shown potential for the elimination of foodborne pathogens on plant seeds. GAP along with other guidelines suggest that attention should be paid to water supply, soil amendments and manure management, harvest equipment sanitation, pest control, personnel training and hygiene, among others, in order to achieve the safest plant product. Despite all these efforts, outbreaks of food contamination on plant materials remain one of the biggest problems in the food industry.

### SUMMARY OF THE INVENTION

The present instrumentalities advance the art by providing a method for reducing pathogens in plant materials. In one embodiment, the methods include contacting a plant material with a composition in an amount effective for reducing the number of at least one pathogen in the plant material, wherein the composition comprises at least one lactic acid producing bacterium (LAB). Examples of the lactic acid producing microorganism may include but are not limited to Lactobacillus acidophilus, Lactococcus lactis, Lactobacillus animalis, Lactobacillus cristpatus and Pediococcus acidilactici. In a preferred embodiment, the lactic acid producing microorganism may include at least two species, or even more preferably, at least four different species selected from the group consisting of Lactobacillus acidophilus, Lactococcus lactis, Lactobacillus animalis, Lactobacillus cristpatus and Pediococcus acidilactici. Examples of the pathogens include but are not limited to E. coli O157:H7, Staphylococcus aureus, Listeria monocytogenes, Campylobacter jejuni, Clostridium botulinum, Clostridium sporogenes, and Salmonella typhimurium.

In one aspect, the at least one lactic acid producing microorganism is at least one strain selected from the group consisting of NP 35, LA45, NP 51, L411, NP 3 and NP 7. In another aspect, the strain may be selected from the group consisting of M35, L411, D3 and L7. More preferably, the lactic acid producing microorganisms of the present disclosure are four strains NP 35, NP 51, NP 3 and NP 7.

The at least one lactic acid producing microorganism may be caused to be in contact with the plant material before, during, or after harvest of the plant material. In one aspect, the lactic acid producing microorganism may be applied to the plant material before harvest when the plant material is still growing, and the lactic acid producing microorganism may be left on the plant material during and after harvest so that the LAB may exert their effect not only before harvest, but also during and after harvest of the plant material. The composition may be in the form of a liquid, a suspension, a solution, a powder and may applied to the plant materials by spraying, sprinkling, or any other methods for distribution of liquid or powders to objects having a large surface area.

For pre-harvest treatment, the lactic acid producing microorganism may be applied to the plant material at planting, or at any time between planting and harvest. Preferably, the lactic acid producing microorganism may be applied at least once at the time of planting, or at a time 1 week, 2 weeks, 3 weeks, or 4 weeks post planting of the plant. In another embodiment of pre-harvest treatment, the lactic acid producing microorganism may be applied to the plant material at least once at a time 1 week, 2 weeks, 3 weeks, or 4 weeks prior to harvest of the plant. Preferably, the composition is electrostatically sprayed onto the plant materials when applied on pre-harvest plant materials. In one aspect, the composition is in a liquid or suspension form and is to be applied to pre-harvest plant materials, wherein the concentration of the lactic acid producing bacterium in the composition is between 5×10⁶ and 5×10¹² CFU per ml, between 5×10⁷ and 5×10¹¹ CFU per ml, between 5×10⁸ and 5×10¹¹ CFU per ml, between 5×10⁹ and 5×10¹¹ CFU per ml, or more preferably, between 1×10¹⁰ and 1×10¹¹ CFU per ml of the composition.

In another aspect, the lactic acid producing microorganism may be applied to the plant material during or after harvest. For instance, the plant materials may be rinsed with, or immersed into a composition containing the lactic acid producing microorganism. In another aspect, the composition is in a liquid or suspension form and is to be applied to post-harvest plant materials, wherein the concentration of the lactic acid producing bacterium in the composition is between 5×10⁶ and 5×10¹¹ CFU per ml, between 5×10⁶ and 5×10¹⁰ CFU per ml, between 5×10⁶ and 5×10⁹ CFU per ml, or more preferably, about 2×10⁸ CFU per ml of the composition.

In another aspect, the concentration of the lactic acid producing bacterium in the composition may be defined based upon the weight of the plant material to be applied to. The composition preferably contains between 5×10⁶ and 5×10¹¹ CFU, between 5×10⁶ and 5×10¹⁰ CFU, between 5×10⁶ and 5×10⁹ CFU, between 5×10⁷ and 5×10⁸ CFU, or more preferably, about 2×10⁸ CFU per 10 grams of the plant material.

In yet another aspect of the present disclosure, the effective amount of the composition may be the amount of the composition that is effective in reducing the total number of the at least one pathogen to below 10³ CFU, 10² CFU, 10¹ CFU, or even more preferably, to 0 CFU per gram of the plant material after the composition is caused to be in contact with the plant material for 30 minutes or longer.

In another aspect, the lactic acid bacteria may be caused to be in contact with the plant material after the plant material has been harvested. The lactic acid bacteria may be incubated with the plant material at a temperature of between 1-30° C. for at least 5 minutes, or more preferably at least 30 minutes. In another aspect, the contacting step may take place at a temperature of between 2-10° C. for at least 30 minutes. In another aspect, the composition may contain the lactic acid bacteria at a concentration effective for reducing by at least 2, or more preferably at least 3-4 the log₁₀ CFU of the at least one pathogen per gram of the plant material.

In another aspect, the contacting step may occur at a temperature of between 18-30° C. for at least 30 minutes, and more preferably, at a temperature of about 25° C. for at least 30 minutes, 1 h, 2 h, 4 h, or more preferably 8 hours, wherein the composition contains a concentration of the lactic acid bacteria effective for reducing by at least 2, or more preferably at least 3-4 the log₁₀ CFU of the at least one pathogen per gram of the plant material.

The treatment of the plant materials by LAB may occur under regular air or under controlled atmosphere. Under certain circumstances, it may be desirable to modify the atmospheric condition such that the controlled atmosphere comprises about 80% oxygen and about 20% carbon dioxide. Alternatively, the controlled atmosphere may comprise about 80% nitrogen and about 20% carbon dioxide. It is preferred that the treatment takes place under regular air.

Plant materials that have been harvested may be rinsed or washed with a second composition containing chlorine to help reduce the number of pathogens in the plant materials. The second composition is preferably in liquid or solution form, and preferably, containing chlorine at a concentration of from about 50 ppm to about 400 ppm, more preferably about 200 ppm. The chlorine is preferably sodium hypochlorite. The treatment step (a) by the lactic acid bacteria and the treatment step (b) by chlorine may occur simultaneously or in order, with step (a) preceding step (b) or vice versa.

### BRIEF DESCRIPTION OF THE DRAWINGS

FIG. 1 shows the concentration of lactic acid bacteria in Lubbock municipal tap water, well water and autoclaved softened water at time points 0, 6, 12, 24, 48 hours.

FIG. 2 shows the concentration of lactic acid bacteria in Lubbock municipal tap water, well water and autoclaved softened water averaged over the forty-eight hours.

FIG. 3 shows the survivability of lactic acid bacteria within the composite sample at harvest when lactic acid bacteria at 10¹⁰ CFU/ml concentration was watered once onto spinach plants during the first four weeks of the growing cycle.

FIG. 4 shows the survivability of lactic acid bacteria within the entire plant sample at harvest when lactic acid bacteria at 10¹⁰ CFU/ml concentration was watered once onto spinach plants during the first four weeks of the growing cycle.

FIG. 5 shows the survivability of lactic acid bacteria within the leaf sample at harvest when lactic acid bacteria at 10¹⁰ CFU/ml concentration was watered once onto spinach plants during the first four weeks of the growing cycle.

FIG. 6 shows the survivability of lactic acid bacteria within the soil sample at harvest when lactic acid bacteria at 10¹⁰ CFU/ml concentration was watered once onto spinach plants during the first four weeks of the growing cycle.

FIG. 7 shows the survivability of lactic acid bacteria within the composite sample at harvest when lactic acid bacteria at 10¹⁰ CFU/ml concentration was electrostatically sprayed once onto spinach plants during the first four weeks of the growing cycle.

FIG. 8 shows the survivability of lactic acid bacteria within the entire plant sample at harvest when lactic acid bacteria at 10¹⁰ CFU/ml concentration was electrostatically sprayed once onto spinach plants during the first four weeks of the growing cycle.

FIG. 9 shows the survivability of lactic acid bacteria within the leaf sample at harvest when lactic acid bacteria at 10¹⁰ CFU/ml concentration was electrostatically sprayed once onto spinach plants during the first four weeks of the growing cycle.

FIG. 10 Survivability of lactic acid bacteria within the soil sample at harvest when lactic acid bacteria at 10¹⁰ CFU/ml concentration was electrostatically sprayed once onto spinach plants during the first four weeks of the growing cycle.

FIG. 11 shows the survivability of lactic acid bacteria within the composite sample at harvest when lactic acid bacteria at 10¹¹ CFU/ml concentration was electrostatically sprayed once onto spinach plants during the first four weeks of the growing cycle.

FIG. 12 shows the survivability of lactic acid bacteria within the entire plant sample at harvest when lactic acid bacteria at 10¹¹ CFU/ml concentration was electrostatically sprayed once onto spinach plants during the first four weeks of the growing cycle.

FIG. 13 shows the survivability of lactic acid bacteria within the leaf sample at harvest when lactic acid bacteria at 10¹¹ CFU/ml concentration was electrostatically sprayed once onto spinach plants during the first four weeks of the growing cycle.

FIG. 14 shows the survivability of lactic acid bacteria within the soil sample at harvest when lactic acid bacteria at 10¹¹ CFU/ml concentration was electrostatically sprayed once onto spinach plants during the first four weeks of the growing cycle.

FIG. 15 shows survival of Escherichia coli O157:H7 at harvest on leaves, stem, roots and soil when Lactiguard™ was applied at specific time periods during the spinach growth cycle. Different superscripts (abc) indicate significant differences between application weeks of LAB when application of E. coli O157:H7 is held constant (P<0.05). Standard Error=0.2851.

FIG. 16 shows the survival of Escherichia coli O157:H7 at harvest on leaves, stem, roots and soil when Lactiguard™ was applied at specific time periods during the spinach growth cycle. Different superscripts indicate significant differences between application weeks of E. coli O157:H7 when application of LAB is held constant (P<0.05). Standard Error=0.2851.

FIG. 17 shows the survival of Lactic acid bacteria at harvest on leaves, stem, roots and soil when applied electrostatically with Lactiguard™ (LAB) at specific time periods during the growth cycle of spinach. Different superscripts indicate significant differences between application weeks of LAB when application of E. coli O157:H7 is held constant (P<0.05). Standard Error=0.6450.

FIG. 18 shows the survival of Lactic Acid Bacteria at harvest on leaves, stem, roots and soil when applied electrostatically with Lactiguard™ (LAB) at specific time periods during the growth cycle of spinach. Different superscripts indicate significant differences between application weeks of E. coli O157:H7 when application of LAB is held constant (P<0.05). Standard Error=0.6450.

FIG. 19 shows the survival of Escherichia coli O157:H7 at harvest on leaves when Lactiguard™ is applied at specific time periods during the spinach growth cycle.

FIG. 20 shows the survival of Escherichia coli O157:H7 at harvest on leaves when Lactiguard™ is applied at specific time periods during the spinach growth cycle.

FIG. 21 shows the survival of Lactic acid bacteria at harvest on leaves when applied electrostatically with Lactiguard™ (LAB) at specific time periods during the growth cycle of spinach.

FIG. 22 shows the survival of Lactic acid bacteria at harvest on leaves when applied electrostatically with Lactiguard™ (LAB) at specific time periods during the growth cycle of spinach.

FIG. 23 shows the survival of Escherichia coli O157:H7 at harvest in soil when Lactiguard™ is applied at specific time periods during the spinach growth cycle

FIG. 24 shows the survival of Escherichia coli O157:H7 at harvest in soil when Lactiguard™ is applied at specific time periods during the spinach growth cycle.

FIG. 25 shows the survival of Lactic acid bacteria at harvest in soil when applied electrostatically with Lactiguard™ (LAB) at specific time periods during the growth cycle of spinach.

FIG. 26 shows the survival of Lactic Acid Bacteria at harvest in soil when applied electrostatically with Lactiguard™ (LAB) at specific time periods during the growth cycle of spinach.

FIG. 27 shows the survival of Escherichia coli O157:H7 at harvest on the entire when Lactiguard™ is applied at specific time periods during the spinach growth cycle.

FIG. 28 shows the survival of Escherichia coli O157:H7 at harvest on the entire plant when Lactiguard™ is applied at specific time periods during the spinach growth cycle.

FIG. 29 shows the survival of Lactic Acid Bacteria at harvest on the entire plant when applied electrostatically with Lactiguard™ (LAB) at specific time periods during the growth cycle of spinach.

FIG. 30 shows the survival of Lactic Acid Bacteria at harvest on the entire plant when applied electrostatically with Lactiguard™ (LAB) at specific time periods during the growth cycle of spinach.

### DETAILED DESCRIPTION OF THE INVENTION

The present disclosure provides methods of contacting a plant material with a composition comprising one or more species of lactic acid producing microorganism, wherein the method affects the content of a pathogen on the plant material.

Plant materials may be contacted with one or more microorganisms to inhibit or prevent the growth of potentially harmful pathogens. This inhibition may reduce or eliminate illnesses resulting from ingestion of the plant materials. Microorganisms that produce lactic acid are particularly attractive for the inhibition of pathogens in plant materials. Microorganisms may be applied to plant materials during growth and fertilization, during harvesting, during processing, during packaging, during storage on shelf or during any combination of such steps. Synergistic effects may be achieved with the administration of multiple strains of microorganisms, or with the administration of one or more microorganisms in combination with certain chemicals. Similarly, synergistic effects may be observed, for example, by multiple or repetitive contacts (a chain of contacts) with the subject anti-pathogen microorganisms prior to human consumption of the plant material.

While not limited by any scientific theory or mode of action, natural competition of certain microorganisms with pathogenic microorganisms may reduce or eliminate enterobacteria. Microorganisms disclosed herein may act in various ways, such as, for example, from acting as or producing bacteriocins to competing with one or more pathogens by using more nutrients and attachment spaces than a pathogen, thus preventing the pathogen from becoming established on plant materials. Advantages of natural competition may be contrasted with less advantageous techniques conventionally known for reducing pathogenic growth such as using aseptic growth techniques.

In a competitive mode of action, particularly of Lactobacillus acidophilus, including without limitation, strain 381-IL-28 (also known as and referred to as LA51, NP 41 or NPC747), one or more microorganisms out-grow and out-populate E. coli O157:H7, thereby acting as an inhibitor to that pathogen. E. coli O157:H7 and Lactobacillus acidophilus are, while not being limited by any mode of action, understood to at least partly utilize the same limited supply of in vitro nutrients such as sugar and also compete for space on the plant material. With a rapid-proliferation inhibitor such as Lactobacillus acidophilus, a mode of action against E. coli O157:H7 is to overwhelm it by using the available food and suitable attachment spaces.

As used herein, a method of contacting the plant material with a composition may mean applying a composition directly or indirectly to the plant material. In various aspects, a composition may be directly applied as a spray, a rinse, or a powder, or any combination thereof. As used herein, a spray refers to a mist of liquid particles that contain a composition of the present disclosure. In one aspect of the present disclosure, a spray may be applied to a plant material while a plant material is being grown. In another aspect, a spray may be applied to a plant material while a plant material is being fertilized. In another aspect, a spray may be applied to a plant material while a plant material is being harvested. In another aspect, a spray may be applied to a plant material after a plant material has been harvested. In another aspect, a spray may be applied to a plant material while a plant material is being processed. In another aspect, a spray may be applied to a plant material while a plant material is being packaged. In another aspect, a spray may be applied to a plant material while a plant material is being stored.

A spray may be applied directly to the plant material using items including, but not limited to, a spray can, a spray bottle, a spray gun. A spray can dispenses a composition of the present invention using a liquid that turns into a gas at room temperature and pressure such as propane/isobutane blends or FREON™, or pressured gasses such as nitrous oxide or ordinary air. As used herein, a spray bottle is a bottle that can be used to squirt, mist or spray fluids. Spray bottles typically use a positive displacement pump that acts directly on the fluid. The pump draws liquid up a siphon tube from the bottom of the bottle, and the liquid is forced out a nozzle. Depending on the sprayer, the nozzle may or may not be adjustable, so as to select between squirting a stream, a mist, or a spray. As used herein, a nozzle used to apply a composition of the present invention refers to a projecting spout from which a liquid is discharged. A nozzle may be plastic or metal. As used herein, a spray gun refers to a tool using compressed air from a nozzle to spray a liquid in very small droplets in a controlled pattern. When the composition is to be sprayed onto a field of plant materials, electrostatic spray is the preferred method.

The terms “lactic acid producing bacteria (or microorganisms)” and “lactic acid bacteria (or microorganisms)” may be used interchangeably in this disclosure and are sometimes abbreviated as “LAB.” Unless otherwise specified, the term CFU in this paragraph refers to the colony forming unit of the LAB. In one aspect, when used in a post-harvest treatment, the concentration of the lactic acid producing microorganisms in the composition of the present disclosure may be, for example, between 1.0×10⁶ CFU/mL and 1.0×10⁹ CFU/mL. More preferably, the concentration may be about 2.0×10⁸ CFU/mL. In another aspect, the concentration of the composition of the present invention may be, for example, a concentration to deliver amounts of about 10⁴ CFU/gram plant material, about 5×10⁴ CFU/gram plant material, about 10⁵ CFU/gram plant material, about 5×10⁵ CFU/gram plant material, about 10⁶ CFU/gram plant material, about 5×10⁶ CFU/gram plant material, about 10⁷ CFU/gram plant material, about 5×10⁷ CFU/gram plant material, about 10⁸ CFU/gram plant material, about 5×10⁸ CFU/gram plant material, about 10⁹ CFU/gram plant material, about 5×10⁹ CFU/gram plant material, about 10¹⁰ CFU/gram plant material, or ranges between any two of these values can be used.

In another aspect, a composition of the present invention may be applied directly to a plant material as a rinse. As used herein, a rinse is a liquid containing a composition of the present invention. Such a rinse may be poured over a plant material. A plant material may also be immersed or submerged in the rinse, then removed and allowed to dry. A rinse may be applied one or more times to a plant material. A rinse comprising a composition of the present invention may be in any concentration, or specifically a concentration described herein. In one aspect of the present invention, a rinse may be applied to a plant material while a plant material is being grown. In another aspect, a rinse may be applied to a plant material while a plant material is being fertilized. In another aspect, a rinse may be applied to a plant material while a plant material is being harvested. In another aspect, a rinse may be applied to a plant material after a plant material has been harvested. In another aspect, a rinse may be applied to a plant material while a plant material is being processed. In another aspect, a rinse may be applied to a plant material while a plant material is being packaged. In another aspect, a rinse may be applied to a plant material while a plant material is being stored.

In one aspect of the present invention, a composition may be applied to a plant material and may cover 50% of the surface area of a plant material. In another aspect, a composition may cover 60%, 70%, 80%, 90%, 95%, 98%, 99% or 100% of the surface area of a plant material.

In another aspect, a composition of the present invention may be applied directly to a plant material as a powder. As used herein, a powder is a dry or nearly dry bulk solid composed of a large number of very fine particles that may flow freely when shaken or tilted. A dry or nearly dry powder composition of the present invention preferably contains a low percentage of water, such as, for example, in various aspects, less than 5%, less than 2.5%, or less than 1% by weight. A powder may be contained in a jar or a canister and may be applied to a plant material by sprinkling or shaking. In another aspect of the present invention, a powder may be applied to a plant material by an apparatus attached to farming equipment such as a truck, a tractor, or a harvester. In one aspect of the present invention, a powder may be applied to a plant material while a plant material is being grown. In another aspect, a powder may be applied to a plant material while a plant material is being fertilized. In another aspect, a powder may be applied to a plant material while a plant material is being harvested. In another aspect, a powder may be applied to a plant material after a plant material has been harvested. In another aspect, a powder may be applied to a plant material while a plant material is being processed. In another aspect, a powder may be applied to a plant material while a plant material is being packaged. In another aspect, a powder may be applied to a plant material while a plant material is being stored.

In another aspect, a composition can be applied indirectly to the plant material. For example, a plant material having a composition already applied may be touching a second plant material so that a composition rubs off on a second plant material. In a further aspect, a composition may be applied using an applicator. In various aspects, an applicator may include, but is not limited to, a syringe, a sponge, a paper towel, or a cloth, or any combination thereof.

A contacting step may occur while a plant material is being grown, while a plant material is being fertilized, while a plant material is being harvested, after a plant material has been harvested, while a plant material is being processed, while a plant material is being packaged, or while a plant material is being stored in warehouse or on the shelf of a store.

In one aspect, a composition may be applied to a plant material, for example, once a day, twice a day, once every two days, once every three days, once every seven days, once every 14 days, once every month, once during each growing season, or one or more times while a plant material is being grown, while a plant material is being fertilized, while a plant material is being harvested, after a plant material has been harvested, while a plant material is being processed, while a plant material is being packaged, or while a plant material is being stored.

A composition as used herein may be a liquid, a heterogeneous mixture, a homogeneous mixture, a powder, or a solid dissolved in a solvent. As used herein, the term “liquid” means a substance in the fluid state of matter having no fixed shape but a fixed volume. Liquids of the present invention are preferably liquid at room temperature and pressure.

As described above, the term “powder” refers to a composition that is a dry or nearly dry bulk solid composed of a large number of very fine particles that may flow freely when shaken or tilted. A dry or nearly dry powder composition of the present invention preferably contains a low percentage of water, such as less than 5%, less than 2.5%, or less than 1% by weight.

In a further aspect, a composition may be a solution. In a solution, a solute is dissolved in a second substance known as a solvent.

In a further aspect, a composition of the present invention may be a suspension. A suspension is a heterogeneous fluid containing solid particles that are sufficiently large for sedimentation. Particles in a suspension are visible under a microscope and will settle over time if left undisturbed.

In a further aspect of the present invention, a composition can be an emulsion. As used herein, the term “emulsion” means a mixture of two immiscible liquids.

In yet another aspect, a composition of the present invention may be a colloidal dispersion. A colloidal dispersion is a type of chemical mixture where one substance is dispersed evenly throughout another. Particles of the dispersed substance are only suspended in the mixture, unlike a solution, where they are completely dissolved within. This occurs because the particles in a colloidal dispersion are larger than in a solution—small enough to be dispersed evenly and maintain a homogenous appearance, but large enough to scatter light and not dissolve. Colloidal dispersions are an intermediate between homogeneous and heterogeneous mixtures and are sometimes classified as either “homogeneous” or “heterogeneous” based upon their appearance.

The method of the present invention may also comprise applying a composition comprising chlorine to a plant material. In one aspect, the chlorine present in a composition of the present invention may be present as sodium hypochlorite. In one aspect, chlorine is present at a concentration of about 50 ppm to about 400 ppm. In another aspect, chlorine is present at a concentration of about 100 ppm to about 300 ppm. In another aspect, chlorine is present at a concentration of about 150 ppm to about 250 ppm. In a preferred aspect, chlorine is present at a concentration of about 200 ppm. In a further aspect of the present invention, a chlorine composition is applied to a plant material before a lactic acid producing microorganism composition. Alternatively, a lactic acid producing microorganism composition may be applied to the plant material before a chlorine composition. In still a further aspect, a lactic acid producing microorganism composition and a chlorine composition are applied to a plant material simultaneously. In another aspect, the application of chlorine and a lactic acid producing microorganism composition may lead to synergistic (rather than additive) desirable effects. Such effects may include desirable effects such as quicker killing of pathogenic bacteria on a plant material, a greater reduction in the number of pathogenic bacteria on a plant material, or prolonged or sustained reduction in growth of pathogenic bacteria.

The lactic acid producing microorganisms of the present invention include any microorganism capable of producing lactic acid. In one aspect, the lactic acid producing microorganism is selected from the group consisting of: Bacillus subtilis, Bifidobacterium adolescentis, Bifidobacterium animalis, Bifidobacterium bifudum, Bifidobacterium infantis, Bifidobacterium longum, Bifidobacterium thermophilum, Lactobacillus acidophilus, Lactobacillus agilis, Lactobacillus alactosus, Lactobacillus alimentarius, Lactobacillus amylophilus, Lactobacillus amylovorans, Lactobacillus amylovorus, Lactobacillus animalis, Lactobacillus batatas, Lactobacillus bavaricus, Lactobacillus bifermentans, Lactobacillus bifidus, Lactobacillus brevis, Lactobacillus buchnerii, Lactobacillus bulgaricus, Lactobacillus catenaforme, Lactobacillus casei, Lactobacillus cellobiosus, Lactobacillus collinoides, Lactobacillus confusus, Lactobacillus coprophilus, Lactobacillus coryniformis, Lactobacillus corynoides, Lactobacillus crispatus, Lactobacillus curvatus, Lactobacillus delbrueckii, Lactobacillus desidiosus, Lactobacillus divergens, Lactobacillus enterii, Lactobacillus farciminis, Lactobacillus fermenturn, Lactobacillus frigidus, Lactobacillus fructivorans, Lactobacillus fructosus, Lactobacillus gasseri, Lactobacillus halotolerans, Lactobacillus helveticus, Lactobacillus heterohiochii, Lactobacillus hilgardii, Lactobacillus hordniae, Lactobacillus inulinus, Lactobacillus jensenii, Lactobacillus jugurti, Lactobacillus kandleri, Lactobacillus kefir, Lactobacillus lactis, Lactobacillus leichmannii, Lactobacillus lindneri, Lactobacillus malefermentans, Lactobacillus mali, Lactobacillus maltaromicus, Lactobacillus minor, Lactobacillus minutus, Lactobacillus mobilis, Lactobacillus murinus, Lactobacillus pentosus, Lactobacillus plantarum, Lactobacillus pseudoplantarum, Lactobacillus reuteri, Lactobacillus rhamnosus, Lactobacillus rogosae, Lactobacillus tolerans, Lactobacillus torquens, Lactobacillus ruminis, Lactobacillus sake, Lactobacillus salivarius, Lactobacillus sanfrancisco, Lactobacillus sharpeae, Lactobacillus trichodes, Lactobacillus vaccinostercus, Lactobacillus viridescens, Lactobacillus vitulinus, Lactobacillus xylosus, Lactobacillus yamanashiensis, Lactobacillus zeae, Pediococcus acidlactici, Pediococcus pentosaceus, Streptococcus cremoris, Streptococcus discetylactis, Streptococcus faecium, Streptococcus intermedius, Streptococcus lactis, Streptococcus thermophilus, and combinations thereof. In one aspect, the lactic acid producing microorganism is selected from the group consisting of Lactobacillus acidophilus, Lactococcus lactis, and Pediococcus acidilactici. In one aspect, the lactic acid producing microorganism is Lactobacillus acidophilus. In another aspect, the lactic acid producing microorganism strains include the M35, LA45, LA51, L411, D3 and L7 strains.

LA51 may be referred to as Lactobacillus acidophilus/animalis because when strain LA51 was first isolated, it was identified as a Lactobacillus acidophilus by using an identification method based on positive or negative reactions to an array of growth substrates and other compounds (e.g., API 50-CHL or Biolog test). Using modern genetic methods, however, strain LA51 has recently been identified as belonging to the species Lactobacillus animalis (unpublished results). Lactobacillus strains C28, M35, LA45, and LA51 strains were deposited with the American Type Culture Collection (ATCC) on May 25, 2005 and have the Deposit numbers of PTA-6748, PTA-6751, PTA-6749, and PTA-6750, respectively. Pediococcus acidilactici strain NP 3 and Enterococcus faecium strain NP 7 were deposited with the American Type Culture Collection (ATCC) on Mar. 8, 2006 and have the Deposit numbers of PTA-7426 and PTA-7425, respectively. These deposits were made in compliance with the Budapest Treaty requirements that the duration of the deposit should be for thirty (30) years from the date of deposit or for five (5) years after the last request for the deposit at the depository or for the enforceable life of a U.S. Patent that matures from this application, whichever is longer. The strains will be replenished should it become non-viable at the depository.

The various aspects of the present invention include application of one or more species of lactic acid producing microorganisms to a plant material. Microorganisms can be different microorganisms, different strains, or a combination of any number of different microorganisms and different strains. For example, one, two, three, four, five, six, or more different microorganisms can be applied. In another aspect, one, two, three, four, five, six, or more different strains of the same microorganism. Various microorganisms can be added sequentially or concurrently as a “cocktail.” Application of multiple different microorganisms, different strains, or a combination of both can lead to synergistic effects. Such effects may include desirable effects such as quicker or more effective killing of pathogenic bacteria on a plant material, a greater reduction in the number of pathogenic bacteria on a plant material, or prolonged or sustained reduction in growth of pathogenic bacteria.

As used herein, the term “one or more” can mean and includes one or more, two or more, three or more, four or more, five or more, six or more, seven or more, eight or more, nine or more, or ten or more.

It is to be noted that, as used in this specification and the claims, the singular forms “a,” “an,” and “the” include plural referents unless the context clearly dictates otherwise. Thus, for example, reference to “a pathogen” includes reference to a mixture of two or more pathogens, reference to “a lactic acid producing bacterium” includes reference to bacterial cells that are lactic acid producing bacteria.

The terms “between” and “at least” as used herein are inclusive. For example, a range of “between 5 and 10” means any amount equal to or greater than 5 but equal to or smaller than 10.

As used herein, the term pathogen refers to a biological agent that causes disease or illness to its host. A pathogen may be a bacterium, a virus, or a fungus. In one aspect of the present invention, a pathogen is a bacterium. In one aspect, a bacterium is an enteropathogenic bacterium, or enteropathogen. In one aspect, the pathogen can be and includes an E. coli pathogen, a Staphylococcus pathogen, a Listeria pathogen, a Shigella pathogen, a Campylobacter pathogen, a Clostridium pathogen, a Mycobacterium pathogen, a Yersinia pathogen, a Bacillus pathogen, a Vibrio pathogen, a Streptococcus pathogen, an Aeromonas pathogen, a Klebsiella pathogen, an Enterobacter pathogen, a Citrobacter pathogen, an Aerobacter pathogen, a Serratia pathogen, and a Salmonella pathogen. In another aspect, the pathogen can be and includes E. coli O157:H7, Staphylococcus aureus, Listeria monocytogenes, Campylobacter jejuni, or Salmonella typhimurium. In a further aspect, the pathogen can be E. coli O157:H7.

A method of the present invention affects pathogen content on a plant material. In one aspect, pathogen content refers to the number of pathogens in a plant material. In another aspect, pathogen content refers to the number of pathogens in a sample of a plant material. In another aspect, pathogen content refers to the number of pathogens in a sub-sample of a plant material. The terms “in” and “on” as used herein, for example, in the phrase “in a plant material,” means one subject, such as a pathogen, is located inside, on the surface of, or anywhere within the physical boundary of another subject, such a plant material.

In another aspect, the pathogen content of a plant material after a contacting step is preferably less than the pathogen content of a plant material before a contacting step. In one aspect, “less than” can mean a fewer number of pathogens on a plant material. In another aspect, “less than” can mean a fewer number of pathogen species on a plant material. In a further aspect, “less than” can mean a fewer number of viable pathogens on a plant material. In one aspect, the affecting of the of pathogen content results in a decrease in the number of pathogens on a plant material or results in a fewer number of pathogens being present. As used herein, a decrease is defined as a lower number of pathogens than were on the plant material before treatment of the plant material with the methods of the present invention. In one aspect, the lower number of pathogens is a lower number of viable pathogens or pathogens capable of replicating. In one aspect, a decrease can be and includes at least about 5%, at least about 10%, at least about 20%, at least about 30%, at least about 40%, at least about 50%, at least about 60%, at least about 70%, at least about 80%, at least about 90%, at least about 95%, at least about 99%, at least about 99.9%, at least about 99.99%, or ideally about 100%.

In a further aspect, affecting the pathogen content results in inhibition of further pathogen growth. In one aspect, pathogen growth is defined as the division of one pathogen cell into two daughter cells. In another aspect, inhibition results in stopping the growth of pathogens on a plant material so that the total number of pathogens on a plant material remains the same. In another aspect, inhibition results in slowing the growth of pathogens on a plant material. Slowing of pathogen growth can occur during the exponential phase of growth and results in a lower number of cell divisions per unit time as compared to a plant material not treated with the methods of the present invention.

In one aspect, inhibition of pathogen growth occurs immediately. In another aspect, inhibition of pathogen growth occurs one minute after, 30 minutes after, 45 minutes after, one hour after, two hours after, four hours after, six hours after, twelve hours after, eighteen hours after, or one day after a composition of the present invention is applied to a plant material.

In one aspect, inhibition of pathogen growth lasts for or provides protection for greater than one or more days, two or more days, three or more days, four or more days, five or more days, one week, two weeks, three weeks, or one month after a composition of the present invention is applied to a plant material. In another aspect of the present invention, inhibition of pathogen growth lasts from one to seven days, from seven to 14 days, from 14 to 21 days, or from 21 to 30 days. In another aspect of the present invention, inhibition of pathogen growth lasts until a plant material is consumed or discarded.

In still a further aspect of the present invention, affecting the pathogen content results in slower growth of pathogens on a plant material as compared to the growth of pathogens on a plant material not treated by the methods of the present invention. Slowing of pathogen growth can occur during the exponential phase of growth and results in a lower number of cell divisions per unit time as compared to a plant material not treated with the methods of the present invention.

In another aspect of the present invention, the pathogen content of a plant material can be measured. Such measurement includes and can be a physical measurement, a chemical measurement, a measurement of chemical activity, or a measurement of turbidity. A physical measurement of pathogen content can be measurement of the dry weight, wet weight, volume or number of pathogen cells after centrifugation. A chemical measurement of pathogen content can be a measure of some chemical component of the pathogen cells such as total nitrogen, total protein, or total DNA content. A measurement of chemical activity can be a measure of rate of O₂ production or consumption, CO₂ production or consumption, or production or consumption of any number of cellular byproducts as would be well-known to a person of ordinary skill in the art. A measure of turbidity employs a variety of instruments to determine the amount of light scattered by a suspension of cells. Particulate objects such as bacteria scatter light in proportion to their numbers. The turbidity or optical density of a suspension of cells is directly related to cell mass or cell number, after construction and calibration of a standard curve. Viability of the pathogen can also be measured. In one aspect, viability can be measured by a physical measurement, a chemical measurement, a measurement of chemical activity, or a measurement of turbidity.

For the methods described herein, a reduction in pathogen content or concentration on the plant material is achieved relative to control samples. A reduction can be measured in any manner commonly used in the art. In a preferred aspect, pathogen concentrations are measured in colony forming units (CFU) obtained from a fixed quantity of plant material. For example, the reduction in the number of CFU can be at least about 5%, at least about 10%, at least about 20%, at least about 30%, at least about 40%, at least about 50%, at least about 60%, at least about 70%, at least about 80%, at least about 90%, at least about 95%, at least about 99%, at least about 99.9%, at least about 99.99%, or ideally about 100%. The reduction can also be ranges between any two of these values. Alternatively, the reduction can be measured in “log cycles.” Each log reduction (also referred to as log CFU or log₁₀ CFU when referring to the reduction in CFU of a pathogen) in concentration is equal to a ten-fold reduction (e.g. a one log reduction is a ten-fold reduction; a two log reduction is a 100-fold reduction, etc.). The log cycle reduction can be at least about 0.5, at least about 1, at least about 1.5, at least about 2, at least about 2.5, at least about 3, at least about 3.5, at least about 4, and ranges between any two of these values. Log cycle reductions can be easily converted to percent reduction. A 1 log cycle reduction is equal to 90%, a 2 log cycle reduction is equal to 99%, a 3 log cycle reduction is equal to 99.9%, and so on. Viability of the pathogen can also be measured. In one aspect, viability can be measured by a physical measurement, a chemical measurement, a measurement of chemical activity, or a measurement of turbidity. In a preferred aspect, viability is measured by quantifying colony forming units (CFU) obtained from a fixed quantity of plant material.

An amount of lactic acid producing microorganism administered to a plant material may generally be any amount sufficient to achieve the desired reduction in amount of pathogen. For example, amounts of about 10⁴ CFU/gram plant material, about 5×10⁴ CFU/gram plant material, about 10⁵ CFU/gram plant material, about 5×10⁵ CFU/gram plant material, about 10⁶ CFU/gram plant material, about 5×10⁶ CFU/gram plant material, about 10⁷ CFU/gram plant material, about 5×10⁷ CFU/gram plant material, about 10⁸ CFU/gram plant material, about 5×10⁸ CFU/gram plant material, about 10⁹ CFU/gram plant material, about 5×10⁹ CFU/gram plant material, about 10¹⁰ CFU/gram plant material, or ranges between any two of these values can be used.

In one aspect of the invention, a composition may be applied to a plant material while a plant material is being fertilized. In one aspect, a composition may be applied to a plant material before a plant material is fertilized. In one aspect, a composition may be applied to a plant material after a plant material is fertilized. In another aspect, a composition may be mixed with fertilizer and applied to a plant material while a plant material is being fertilized. An application can be performed in generally any known method, including those as described herein. Methods can include spraying a liquid composition, spraying, sprinkling or shaking a dried composition, and rinsing a plant material with a liquid composition. A concentration of the microorganisms in a liquid or dry composition can generally be any suitable concentration, including those as described herein. A concentration is preferably sufficient to achieve a desired reduction in number of pathogens on the plant material. A reduction can be measured relative to the pathogen level prior to administration of the microorganisms. A reduction can also be measured by counting the absolute number of colonies formed by a culture of the plant material. In a preferred aspect of the invention, a reduction can be measured relative to a similar plant material that was not treated with the microorganisms. The concentration of microorganisms can be adjusted depending on the volume of composition applied.

In a further aspect of the invention, a composition can be applied to a plant material while a plant material is being harvested. An application can be performed by generally any known method, preferably described herein. Methods can include spraying a liquid composition, spraying, sprinkling or shaking a dried composition, and rinsing a plant material with a liquid composition.

In another aspect of the invention, a composition can be applied to a plant material after the plant material has been harvested. Application can be performed by generally any known method as described herein. Methods can include spraying a liquid composition, spraying, sprinkling or shaking a dried composition, and rinsing a plant material with a liquid composition.

In an alternative aspect of the invention, a composition can be applied to a plant material while a plant material is being processed after harvesting. Processing of a plant material can include cleaning, sorting, washing, rinsing, grinding, or shelling. The application of the microorganisms can be performed by generally any known method, particularly those described herein. Methods can include spraying a liquid composition, spraying, sprinkling or shaking a dried composition, and rinsing plant material with a liquid composition.

In an alternative aspect of the invention, a composition can be applied to a plant material while a plant material is being packaged. Application can be performed in generally any known method, particularly those described herein. Methods can include spraying a liquid composition, spraying, sprinkling or shaking a dried composition, and rinsing a plant material with a liquid composition.

Another aspect of the invention includes a method of applying a composition comprising at least one species of lactic acid producing microorganism to a plant material, wherein such an application affects the content of a pathogen on a plant material, and wherein application is performed with farming equipment such as a truck, a tractor, an irrigation equipment, or a harvester.

A truck for use in applying the composition of the present invention can be, for example, a pick-up truck or any type of truck useful in agricultural applications.

A tractor, as used herein, is a farm vehicle used for agricultural applications including, but not limited to, pulling or pushing agricultural machinery or trailers, for plowing, tilling, disking, harrowing, planting, and similar tasks.

A harvester for use in applying the composition of the present invention can be, for example, any machine used to harvest plant materials. The harvester can be, for example, a thresher, a reaper or a combine.

In a preferred aspect of the present invention, the composition is applied using an apparatus mounted to farming equipment such as a truck, a tractor or a harvester. As used herein, such an apparatus may be a spray gun, a spray can, a spray bottle, a spray nozzle, or a hose attached to a spray nozzle. In a preferred aspect, the composition of the present invention is contained within a reservoir and is forced through a hose attached to a spray nozzle.

A plant material of the present invention may be any material produced by a plant or any part of a plant. In one aspect, a plant material may be a fruit or a seed. As used herein, the term “fruit” means the ripened ovary and surrounding tissues of a flowering plant. In one aspect of the present invention, a fruit can be a berry, a fleshy fruit, a melon or a citrus fruit.

Fruits encompassed by the present invention include berries such as blueberries, raspberries, blackberries, strawberries, boysenberries, gooseberries, and cranberries. In another aspect, a fruit is a fleshy fruit such as an apple, a peach, an apricot, a pear, a plum, a grape, a cherry, a nectarine, a kiwi, a fig, and a pineapple. In a further aspect, a fruit is a melon such as a watermelon or a muskmelon. A watermelon of the present invention includes and can be a Carolina Cross melon, a Yellow Crimson watermelon, an Orangeglo watermelon, a Moon and Stars watermelon, a Cream of Saskatchewan watermelon, a Melitopolski watermelon or a Densuke watermelon. A muskmelon of the present invention can be a cantaloupe, a honeydew, a Bailan melon, a Galia melon, a Hami melon, a Montreal melon, a Sugar melon, or a casaba. In still a further aspect, the fruit is a citrus fruit such as an orange, a grapefruit, a lemon, a lime, a clementine, a pummelo, a tangelo or a tangerine.

In another aspect, a plant material of the present invention may be a vegetable. In one aspect, the term “vegetable” means any edible part of a plant. In one aspect, a vegetable is a leafy vegetable such as spinach, lettuce, kale, mustard greens, collards, chard, escarole, turnip greens, endive or watercress.

In an aspect of the present invention, a leafy vegetable is lettuce. In a further aspect, the lettuce can be Butterhead lettuce, Crisphead lettuce, Romaine lettuce, or Leaf lettuce. The Butterhead lettuce includes and can be Boston lettuce, Bibb lettuce, Buttercrunch lettuce, Ermosa lettuce, Esmerelda lettuce, Nancy lettuce, Tania lettuce, Tom lettuce or Thumb lettuce. A Crisphead lettuce includes and can be Great Lakes lettuce, Ithaca lettuce, Onondaga lettuce, Mesa 659 lettuce, Raleigh lettuce, Iceberg lettuce, Imperial lettuce, Vanguard lettuce, Western lettuce or South Bay lettuce. A Romaine lettuce includes and can be Cos lettuce, Green Towers lettuce, or Valmaine lettuce. A Leaf lettuce includes and can be Black Seeded Simpson lettuce, Grand Rapids lettuce, Lollo Rosso lettuce, New Red Fire lettuce, Green Ice lettuce, Red Sails lettuce, Oak Leaf lettuce, Prizehead lettuce, Ruby lettuce, Sierra lettuce, Slobolt lettuce, Tierra lettuce, Salad Bowl lettuce or Waldmann's Green lettuce.

In another aspect of the present invention, a leafy vegetable is spinach. In one aspect of the present invention, spinach can be savoy spinach, semi-savoy spinach, flat-leaf spinach, or baby spinach.

In a further aspect of the present invention, spinach can be savoy spinach. Savoy spinach has dark green, crinkly and curly leaves and is the type sold in fresh bunches in most supermarkets.

In various aspects of the present invention, spinach can be semi-savoy spinach. Semi-savoy spinach is a hybrid of savoy spinach and flat-leaf spinach, and has slightly crinkled leaves. It has the same texture as savoy, but it is not as difficult to clean. It is grown for both fresh market and processing.

In yet another aspect of the present invention, spinach can be flat-leaf spinach. Flat-leaf spinach has broad smooth leaves that are easier to clean than savoy. This type is often grown for canned and frozen spinach, as well as soups, baby foods, and processed foods.

In another aspect of the present invention, the spinach can be baby spinach. Baby spinach is a variety of spinach with flat, spade-shaped leaves that are soft and tender in texture. While mature bunched spinach generally requires blanching to mellow its bitter taste, baby spinach is clean and mild in flavor and the leaves and stems can be eaten raw.

In yet another aspect of the present invention, a plant material can be a root vegetable. A root vegetable is a plant root used as a vegetable. Root vegetables suitable for use in the present invention include beets, carrots, turnips, radishes, potatoes, sweet potatoes, yams and parsnips.

In another aspect of the present invention, a plant material can be a cruciferous vegetable. Edible plants in the family Brassicaceae (also called Cruciferae) are termed cruciferous vegetables. Cruciferous vegetables suitable for use in the present invention include broccoli, cauliflower, Brussels sprouts, cabbage, kale, collard greens, kohlrabi, bok choy, broccoli rabe, rutabaga, mustard seed, and horseradish.

In an aspect of the present invention, a plant material can be a squash or a gourd. Squash and gourds suitable for use in the present invention include cucumbers, calabash, spaghetti squash, acorn squash, butternut squash, autumn cup squash, ambercup squash, Australian blue squash, banana squash, buttercup squash, calabaza, carnival squash, kabocha squash, zucchini, and pumpkins.

In another aspect, a plant material can be an edible stem vegetable. In one aspect, an edible stem vegetable can be and includes celery or asparagus.

In still another aspect, a plant material can be an allium vegetable. Allium vegetables suitable for use in the present invention include and can be onions, garlic, and shallots.

In a further aspect of the present invention, a plant material can be grown from a monocot. Plant materials grown from a monocot include and can be corn, maize, wheat, rice, sorghum, oats, barley, rye, onion, garlic and asparagus.

In another aspect of the present invention, a plant material can be grown from a dicot. Plant materials grown from a dicot include and can be broccoli, cauliflower, turnips, cabbage, beans, peas, peanuts, soybeans, carrots, celery, parsley, apples, peaches, pears, plums, potatoes, beets, tomatoes, artichokes, mushrooms, avocadoes and peppers.

In a further aspect, a plant material can be a legume. Legumes suitable for use in the present invention include and can be peas, lentils, beans and peanuts. In other aspects of the present invention, the bean can be a soy bean, a mung bean, a broad bean, a green bean, an adzuki bean, a kidney bean, a lima bean, a black bean, a garbanzo bean, a navy bean, a pinto bean or an anasazi bean.

In another aspect, a plant material can be a nut. As used herein, the term “nut” is a general term for the large, dry, oily seeds or fruit of some plants. Nuts suitable for use in the present invention include almonds, hazelnuts, Brazil nuts, pecans, walnuts, cashews, chestnuts, hazelnuts, macadamias, pine nuts and pistachios.

In another aspect, a plant material can be a seed. Seeds suitable for use in the present invention can be and include a sunflower seed, a pumpkin seed, a pine nut, or a sesame seed.

In another aspect, a plant material can be a dried fruit. A dried fruit can be and includes a raisin, a dried cranberry, a dried apricot, a dried cherry, a prune, a dried apple, or any fruit disclosed herein that is suitable for drying.

In another aspect of the present invention, a plant material can be an herb. Herbs suitable for use in the present invention include and can be allspice, anise, basil, basil, bay leaf, brown mustard, caraway, cardamom, chervil, chives, cilantro, cinnamon, clove, coriander, cumin, dill, fennel, lavender, lemongrass, nutmeg, oregano, parsley, peppermint, rosemary, saffron, sage, spearmint, tarragon, and thyme.

The Examples below are provided to illustrate but not to limit the invention. Those of skill in the art should, in light of the present disclosure, appreciate that many changes may be made in the specific aspects which are disclosed within the following examples and elsewhere and still obtain a like or similar result without departing from the scope of the invention.

### EXAMPLES

### Example 1

### Inhibitory Activities of Various Microorganism on Pathogen Growth

Lyophilized cultures of lactic acid producing and lactate utilizing organisms are selected for their ability to inhibit the growth of pathogens such as E. coli O157:H7, Streptococcus aureus and Salmonella. Combinations of the lactic acid producing and lactate utilizing organisms are further selected for their ability to maximize the inhibition of growth of the various pathogens.

In vitro tests are conducted to identify particularly effective single strains. Seven strains of Propionibacterium and six strains of Lactobacillus are screened for their ability to produce bacteriocins capable of creating zones of inhibition on agar plates that are grown with E. coli O157:H7 (See Table 1 and Table 2).

TABLE 1
Inhibitory Activity of Propionibacterium Strains
Grown in Selective Media

| PATHOGEN | P9 | P42 | P79 | P88 | P93 | P99 | PF24 |
|---|---|---|---|---|---|---|---|
| Gram + | | | | | | | |
| B. cereus | No | No | No | No | No | No | No |
| S. aureus | Yes | Yes | Yes | No | No | No | No |
| Gram − | | | | | | | |
| E. coli O157:H7 | Yes | Yes | No | No | Yes | Yes | Yes |
| Sal. typhirium | No | Yes | No | Yes | Yes | Yes | Yes |

TABLE 2
Inhibitory Activity of Lactobacillus Strains
Grown in Selective Media

| PATHOGEN | 30SC | 53545 | 381IL28 | C28 | FR3 | R2 |
|---|---|---|---|---|---|---|
| E. coli 43985 | −4.1 | 16.8 | 91.8 | 89.7 | 88.7 | 64.9 |
| O157:H7 | | | | | | |
| E. coli 933 | 28.1 | −3.4 | 92.7 | 93.5 | 91 | 89.4 |
| O157:H7 | | | | | | |
| S. aureus | −15.6 | −22.1 | 82.6 | 80.6 | 84.8 | 23.3 |

### Example 2

### Comparison of the Growth of Selected Microorganisms and the Pathogen E. coli O157:H7

Selected strains of Lactobacillus acidophilus and Propionibacterium freudenreichii bacteria were grown in an in vitro comparison with E. coli O157:H7 on rich semi-anaerobic media at 38° C. to assess competition with E. coli growth under in vivo growth conditions. LA51 and LA45 strains out-grow E. coli (See Table 3).

TABLE 3
Growth (Optical Density) of Selected Strains of Bacteria versus
E. coli O157:H7 on Rich Semi-Anaerobic Media at 38° C.

| MINUTES | E. coli O157:H7 | LA45 | LA51 | PF24 |
|---|---|---|---|---|
| 0 | 0.2 | 0.2 | 0.2 | 0.2 |
| 50 | 0.3 | 0.38 | 0.55 | 0.3 |
| 90 | 0.45 | 0.65 | 0.84 | 0.35 |
| 120 | 0.60 | 0.85 | 1.0 | 0.36 |
| 200 | 0.80 | 1.2 | 1.28 | 0.38 |
| 230 | 0.85 | 1.25 | 1.28 | 0.39 |
| 365 | 0.90 | 1.25 | 1.28 | 0.50 |
| 440 | 0.90 | 1.25 | 1.28 | 0.58 |

### Example 3

### Post-Harvest Treatment of Spinach by LAB Helps Reduce Pathogen Content

Spinach samples were inoculated with E. coli O157:H7. Spinach samples were then rinsed with sterile distilled water and a four-strain lactic acid producing microorganism (LAB) cocktail at a target concentration of 2.0×10⁸ CFU/mL. Both treatments were then compared to an inoculated control throughout the 24-hour sampling period at 7° C. Reductions achieved by water and LAB were significant at 0.88 logs (p<0.0001) and 1.03 logs (p<0.0001) respectively, in comparison to the control sample. The improved reduction by LAB over water was significant (p=0.0363), indicating that LAB is the most effective treatment in the present study.

A cocktail of four E. coli O157:H7 strains was used for this study and includes A4 966, A5 528, A1 920 and 966. All strains had been isolated from cattle and originally obtained from the University of Nebraska. The cocktail is prepared by making frozen concentrated cultures of each culture as described by Brashears et al. (Brashears M M et al., J. Food Prot. 61:166-170, 1998, herein incorporated by reference in its entirety). One vial from each strain was obtained from the −80° C. stock culture. A sterile loop was used to add the strains to separate tubes of Brain Heart Infusion Broth (BHI) (EMD, Gibbstown, N.J.). The strains were incubated overnight at 37° C., transferred into fresh BHI tubes and incubated an additional night at 37° C. The concentration of each strain was determined to be at the appropriate level by plating on Tryptic Soy Agar (TSA) (EMD, Gibbstown, N.J.) and incubating for 24 hours at 37° C. All four strains were combined in equal volumes in BHI, allowed to grow at 37° C. overnight and then centrifuged for 10 minutes at 4,000 g. The pellet was resuspended in BHI containing 10% glycerol and stored as a frozen culture at −80° C. in 1 ml portions at a concentration of 1.0×10⁹ CFU/ml in the Texas Tech University inventory.

Lactiguard™ used in this study was obtained from Nutrition Physiology Corporation (Guymon, Okla.). This commercially available LAB material is comprised of four LAB strains, including Lactobacillus acidophilus (NP 51), Lactobacillus cristpatus (NP 35), Pediococcus acidilactici (NP 3) and Lactobacillus lactis subsp. lactis (NP 7) (Smith J et al., J. Food Prot. 68:1587-1592, 2005, herein incorporated by reference in its entirety). Isolates NP 51 and NP 35 were originally isolated from cattle, while NP 3 was isolated from cooked hot dogs and NP 7 from alfalfa sprouts (Smith J et al., J. Food Prot. 68:1587-1592, 2005, herein incorporated by reference in its entirety). The culture was commercially prepared and packaged in 10 g portions in a freeze-dried form prior to shipping to Texas Tech University.

Fresh bagged baby spinach was obtained from a local grocery store and weighed into a poultry rinsate bag (VWR, West Chester, Pa.) to ensure total weight is approximately 500 g. The four-strain cocktail of Escherichia coli O157:H7 was diluted 1:1000 in buffered peptone water (BPW) (OXOID, Basingstoke, Hampshire, England) to obtain a final concentration of 1.0×10⁶ CFU/ml and an inoculum volume of 5 L. The pre-weighed spinach was submerged in the inoculum and allowed to soak for 20 minutes to facilitate attachment. Using sterile tongs, the inoculated spinach was spread evenly across sterile drying racks in a biological hood (Fisher Hamilton model #54L925, Two Rivers, Wis.) and allowed to dry for one hour. A LAB wash with a concentration of 2.0×10⁸ CFU/ml was prepared by combining 5 g of freeze-dried Lactiguard™ with 495 ml of sterile distilled water. The concentration of LAB was determined by making serial dilutions in buffered peptone water and plating on Lactobacilli MRS Agar (MRS) (EMD, Gibbstown, N.J.). The MRS agar plates were incubated at 37° C. for 24 to 48 hours. A control wash consisting of 500 ml of sterile distilled water was also prepared. Upon completion of drying, 100 g of the dry, inoculated spinach was added to the LAB rinse and 100 g to the control water rinse in sterile poultry rinsate bags. The bags were agitated for 1 minute at 230 rpm on an automatic orbital shaker (KS 260 Basic, IKA, Wilmington, N.C.). A third set of 100 g of dry, inoculated spinach was placed directly into a sterile Whirl-Pak (Nasco, Fort Atkinson, Wis.) bag to serve as the background control for this experiment. Following agitation, both rinse treatments were allowed to soak during the 0, 5 and 10 minute sampling time points. After 10 minutes, each rinse was drained in a sterile colander and transferred to sterile Whirl-Pak bags using sterile tongs. All samples were stored at 7° C. between sampling intervals.

From each rinse and the background control, 10 g of spinach was collected at 0, 5 and 10 minutes, 1, 4, 8 and 24 hours. The exact sample weight was recorded and used to determine colony forming units (CFU) on a per gram basis. At each time point, the sampled spinach was stomached (Seward Model 400, Bohemia, N.Y.) with 90 ml of buffered peptone water at 230 rpm for 2 minutes. Homogenized samples were serially diluted and quantitatively analyzed for Escherichia coli O157:H7 using the NEO-GRID™ Method (Neogen, Lansing, Mich.). NEO-GRID™ filters are placed on CHROMagar (CHROMagar, Paris, France) containing tellurite at a level of 2.5 mg/L. CHROMagar plates were incubated at 37° C. for 24±2 hours. Mauve colonies were counted as presumptive positive for Escherichia coli O157:H7 and agglutinated at random for confirmation using a latex agglutination kit (Remel, Lenexa, Kans.).

This study was classified as a complete randomized block design. The Statistical Analysis System (SAS) software was used to analyze the data. All data were subjected to the PROC MIXED and PROC UNIVARIATE commands The Least Squares (LS) means obtained from SAS were used to identify statistical significance between each individual treatment in comparison to the control. Additionally, the LS means of the water and LAB washes were compared. The Shapiro-Wilk value provided by the PROC UNIVARIATE procedure was used to determine normality of the data. The experimental procedure was replicated a total of three times (See Table 4).

TABLE 4
Least Squares Means of E. coli O157:H7 levels (Log₁₀ CFU/g) in each spinach treatment
held at the target temperature of 7° C. for 24 hours.

| Treatment | 0 Min.^{z} | 5 Min. ^{z} | 10 Min. ^{z} | 1 Hour ^{z} | 4 Hours ^{z} | 8 Hours ^{z} | 24 Hours ^{z} |
|---|---|---|---|---|---|---|---|
| Control | 5.20^{a} | 5.34 ^{a} | 5.38 ^{a} | 5.23 ^{a} | 5.36 ^{a} | 5.23 ^{a} | 5.38 ^{a} |
| Water | 4.71^{b} | 4.61 ^{b} | 4.48 ^{b} | 4.50 ^{b} | 4.35 ^{b} | 4.17 ^{b} | 4.08 ^{b} |
| LAB¹ | 4.50^{b} | 4.46 ^{b} | 4.33 ^{b} | 4.26 ^{b} | 4.18 ^{b} | 4.36 ^{b} | 3.83 ^{b} |

^{a,b} indicates treatments that differ in each column (p < 0.05).
^{z} indicates standard error for all values within column is equal to 0.3794.
¹LAB is representative of the Lactiguard ™ lactic acid bacteria treatment.

### Example 4

### Post-Harvest Treatment Using LAB and Chlorine Reduces Pathogen Content in Spinach

A 12 day shelf-life study was conducted at a temperature of 7° C. The multi-hurdle intervention was applied to the spinach as a rinse and is evaluated in comparison to LAB, chlorine and water rinses. Reductions achieved by all treatments were also compared to an inoculated control. The spinach was inoculated by submersion with E. coli O157:H7 at a concentration of 1.0×10⁶ CFU/ml. LAB was applied as a post-harvest intervention at a target concentration of 2.0×10⁸ CFU/ml while chlorine was utilized at the 200 ppm level. All spinach samples were held in a retail display case and tested for E. coli O157:H7 on days 0, 1, 3, 6, 9 and 12 using the Neo-Grid Filtration System and CHROMagar. Survivability of the LAB cultures throughout the shelf-life was also determined. Significant reductions in pathogen populations were achieved by water (P=0.0008), LAB (P<0.0001), chlorine (P<0.0001) and multi-hurdle treatments (P<0.0001) when compared to control populations. However, the multi-hurdle treatment produces the greatest reductions from control populations with a 1.91 log cycle reduction. This reduction was greater than with water (P<0.0001), LAB (P=0.0025) and chlorine (P<0.0001) alone.

A cocktail of four E. coli O157:H7 strains was used for this study and includes A4 966, A5 528, A1 920 and 966. All strains were isolated from cattle and originally obtained from the University of Nebraska and are now maintained in the stock culture collection at Texas Tech University. The cocktail was prepared by making frozen concentrated cultures of each culture as described by Brashears et al. (Brashears M M et al., J. Food Prot. 61:166-170, 1998, herein incorporated by reference in its entirety). One vial from each strain was obtained from the −80° C. stock culture. A sterile loop was used to add the strains to separate tubes of Brain Heart Infusion Broth (BHI) (EMD, Gibbstown, N.J.). The strains were incubated overnight at 37° C., transferred into fresh BHI tubes and incubated another night at 37° C. The concentration of each strain was determined to be at the appropriate level by plating on Tryptic Soy Agar and incubating at 37° C. overnight (TSA) (EMD, Gibbstown, N.J.). All four strains were combined in equal volumes in BHI, allowed to grow at 37° C. overnight and then centrifuged for 10 minutes at 4,000 g. The pellet was resuspended in BHI containing 10% glycerol and stored as a frozen culture in 1 ml portions at a concentration of 1.0×10⁹ CFU/ml in the Texas Tech University inventory.

Lactiguard™ was obtained from Nutrition Physiology Corporation (Guymon, Okla.) and used in this study. Lactiguard™ was commercially available and contained four LAB strains, including Lactobacillus acidophilus (NP 51), Lactobacillus cristpatus (NP 35), Pediococcus acidilactici (NP 3) and Lactobacillus lactis subsp. lactis (NP 7) (See e.g., Smith J et al., J. Food Prot. 68:1587-1592, 2005, herein incorporated by reference in its entirety). Isolates NP 51 and NP 35 were originally isolated from cattle, while NP 3 was isolated from cooked hot dogs and NP 7 from alfalfa sprouts (Smith J et al., J. Food Prot. 68:1587-1592, 2005, herein incorporated by reference in its entirety). The culture was prepared by a commercial manufacturer and packaged in 10 g portions in a freeze-dried form.

A LAB wash with a concentration of 2.0×10⁸ CFU/ml was prepared by combining one 10 g packet of freeze-dried Lactiguard™ with 990 ml of buffered peptone water (BPW) (OXOID, Basingstoke, Hampshire, England) containing 1% glucose. The concentration of LAB was determined by making serial dilutions in buffered peptone water and plating on Lactobacilli MRS Agar (MRS) (EMD, Gibbstown, N.J.). In order to metabolically activate the bacteria, the LAB was held in a 37° C. incubator for 1 hour. The concentration of the LAB wash was re-evaluated post-incubation by serially diluting and plating on Lactobacilli MRS Agar. A 200±10 parts per million (ppm) chlorine wash was prepared by combining 7.6 ml of sodium hypochlorite germicidal bleach (The Clorox Company, Oakland, Calif.) with 2.0 L of sterile tap water. The mixture was stirred and the concentration of total chlorine is determined using Hanna Instruments HI 95771 Ultra High Range meter (Hanna Instruments, Woonsocket, R.I.). Instructions provided by the manufacturer were followed. If the total chlorine concentration was not acceptable, the solution was adjusted and retested until the target range was achieved. A sterile tap water wash was also prepared with a total volume of 1.0 L.

Fresh spinach was obtained from a commercial grower in California. The material was shipped overnight the same day that it was harvested, arriving at Texas Tech University approximately 24 hours later. A total of 1,500 g of the spinach was weighed into sterile plastic bags (VWR, West Chester, Pa.). The four-strain cocktail of Escherichia coli O157:H7 was diluted 1:1000 in buffered peptone water (BPW) (OXOID, Basingstoke, Hampshire, England) to obtain a final concentration of 1.0×10⁶ CFU/ml and an inoculum volume of 13 L. The pre-weighed spinach was submerged in the inoculum and allowed to soak for 20 minutes to facilitate attachment. Using sterile tongs, the inoculated spinach was spread evenly across sterile drying racks in a biological safety level II hood (Fisher Hamilton model #54L925, Two Rivers, Wis.) and allowed to dry for one hour. After 30 minutes of drying, the spinach was flipped, to ensure uniform air exposure, and allowed to remain for an additional 30 minutes.

Upon completion of drying, 200 g of the dry, inoculated spinach was added to a poultry rinsate bag and set aside to serve as the control. The remainder of the dry spinach was weighed into 4 sterile bags, with 200 g in each bag. Spinach in each of the 4 bags was ultimately exposed to a different treatment.

All treatments were added to the rinsate bags and agitated by hand for one minute. The rinse treatments were as follows: 500 ml of the 2.0×10⁸ LAB solution, 500 ml of 200 ppm sodium hypochlorite, 500 ml of sterile tap water and a multi-hurdle intervention that was initially rinsed with 500 ml of 200 ppm sodium hypochlorite followed by 500 ml sterile tap water and 500 ml of the 2.0×10⁸ LAB solution. Following agitation, all rinse treatments were drained into a sterile colander and transferred to a sanitized salad spinner (Farberware, Garden City, N.Y.). The spinach was spun 20 times, transferred to a new poultry rinsate bag and set aside. Prior to beginning each replication, the salad spinners were sanitized with 95% ethanol.

Plastic rollstock used in the packaging of fresh spinach was provided by an industry contact and utilized in this study. Prior to the beginning of each replication, the oxygen-permeable rollstock was cut and sealed to create bags with the approximate dimensions of 26.0 cm long and 11.45 cm wide. The seal function of a FoodSaver (Gamesaver Deluxe Plus model) was used to create all seals on the bags.

Using sterile tongs, 25±1 g were added to each pre-made spinach bag, with a total of 7 bags created per treatment. The bags were sealed and labeled with their respective replication and treatment. At the completion of packaging, all spinach bags were randomized and placed onto one of three shelves in a retail display cooler set at 7° C. It should be noted that samples from each treatment are randomized across all three shelves and throughout the entire length of the cooler to reduce bias.

The temperature of the retail display case was continuously recorded using a continuous temperature recorder (Temprecord Temperature Recorder MKII, Auckland, New Zealand). Before beginning the study, the temperature was set to 7° C. and monitored throughout storage. Each shelf contains a temperature logger that was randomly placed in the case. The temperature of each shelf was retrieved from the loggers at the end of the study.

From each treatment and the control, one bag was randomly selected from the retail display cooler. The bags were opened with sterile scissors and 10 g of spinach is collected on day 0, 1, 3, 6, 9 and 12. The exact sample weight was recorded and used to determine colony forming units (CFU) on a per g basis. At each time point, the spinach was stomached (Seward Model 400, Bohemia, N.Y.) with 90 ml of buffered peptone water at 230 rpm for 2 minutes. Homogenized samples are serially diluted and quantitatively analyzed for Escherichia coli O157:H7 using the NEO-GRID™ Method (Neogen, Lansing, Mich.). NEO-GRID™ filters were placed on CHROMagar (CHROMagar, Paris, France) containing tellurite, cefixime, cefsulodin and novobiocin at levels of 2.5 mg/L, 25 μg/L, 5 mg/L and 5 mg/L, respectively. Each antibiotic was added to reduce the interference from other bacteria. CHROMagar plates were incubated at 37° C. for 24±2 hours. Mauve colonies were counted as presumptive positive for Escherichia coli O157:H7 and agglutinated at random for confirmation using a latex agglutination kit (Remel, Lenexa, Kans.). The survivability of LAB was also determined by spread plating on Lactobacilli MRS Agar (MRS) (EMD, Gibbstown, N.J.). MRS plates were incubated for 24-48 hours at 37° C. All colonies were counted and presumed to be LAB.

This study is classified as a complete randomized block design. The Statistical Analysis System (SAS) software was used to analyze the data. All data were subjected to the PROC MIXED and PROC UNIVARIATE commands The Least Squares (LS) means obtained from the PROC MIXED procedure were used to identify statistical significance between each individual treatment in comparison to the control. Additionally, the LS means of each rinse treatment were compared to one another. Survivability of LAB was determined for the LAB and hurdle treatments at each sampling point by calculating the mean of all replications using Microsoft Excel 2007. The Shapiro-Wilk value provided by the PROC UNIVARIATE procedure was used to determine normality of the data. The experimental procedure was replicated a total of three times (See Table 5).

TABLE 5
Average survivability of lactic acid bacteria on spinach at each
sampling time point for only the LAB and multi-hurdle treatments
held in a retail display cooler at a target temperature of 7° C. for
12 days (Log₁₀ CFU/g).

| Treatment | Day 0 | Day 1 | Day 3 | Day 6 | Day 9 | Day 12 |
|---|---|---|---|---|---|---|
| LAB¹ | 7.61 | 7.65 | 7.49 | 7.24 | 7.11 | 6.88 |
| Hurdle | 7.54 | 7.48 | 7.47 | 7.16 | 7.12 | 6.89 |

¹LAB is representative of the Lactiguard ™ lactic acid bacteria treatment.

### Example 5

### Survivability of Lactic Acid Producing Bacteria (LAB) in Water

To evaluate the survivability of the LAB strains such as Lactiguard™ in different water sources, the strains were inoculated in 3 different water sources and incubated for a two day storage period in weather conditions similar to the central Californian fall season. The three water sources are: tap water, autoclaved water and well water. CFU of the LAB was monitored and enumerated over the 48-hour storage period. Both water type and incubation time had significant impact on the survivability of the LAB strains (P=0.0010 and P=0.0227, respectively).

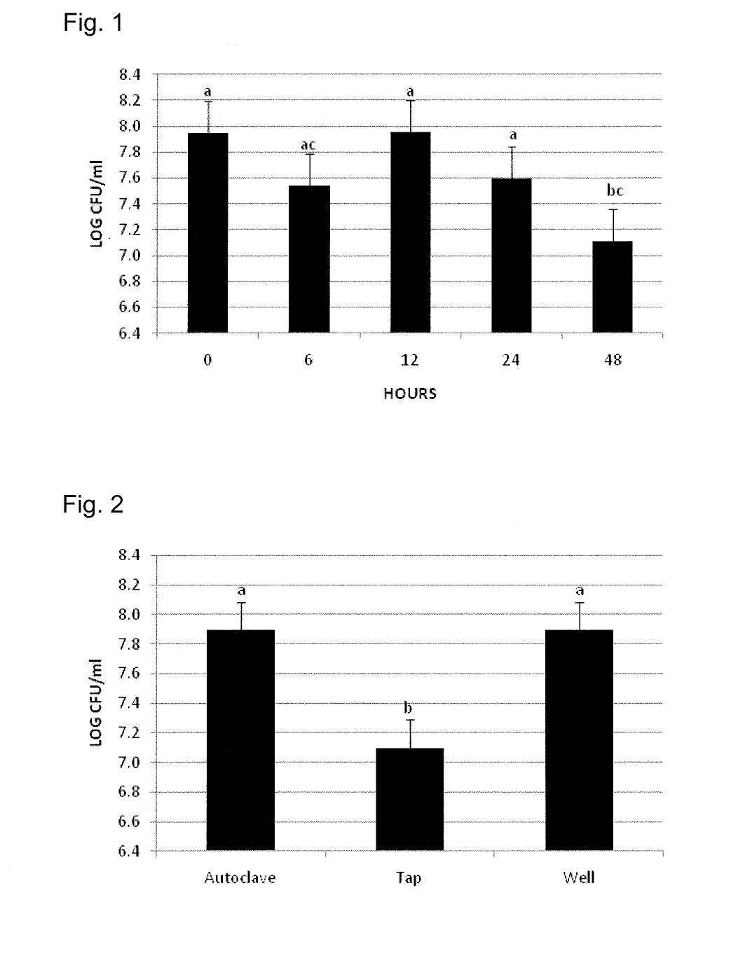

FIG. 1 shows the concentration of lactic acid bacteria in Lubbock municipal tap water (Tap, hardness level 289 ppm), well water from a local farm (Well, hardness level 110 ppm), and autoclaved softened water (autoclaved, 40 ppm) at time points 0, 6, 12, 24, 48 hours. FIG. 2 shows the concentration of lactic acid bacteria in Lubbock municipal tap water (Tap, hardness level 289 ppm), well water from a local farm (Well, hardness level 110 ppm), and autoclaved softened water (autoclaved, 40 ppm) averaged over the forty-eight hours.

Sampling times of hours 0, 6, 12, and 24 were not significantly different (P>0.05). The 48 hour sampling time was significantly lower than hours 0, 12, and 24 (P<0.05), but not significantly lower than the 6 hour sampling time (P=0.8180). The autoclaved water and the well water samples had significantly higher numbers of LAB survive over the 48 hour experiment when compared to the tap water, resulting in a reduction of less than 1 log CFU/ml (P<0.0001). Over the next 48 hour time period, all three sources of water reduced the LAB numbers by 1.5 log CFU/ml (P=0.0042). The autoclaved water and the well water allowed greater LAB survivability than the tap water source (P<0.05).

The ability of Lactiguard™ to survive in the three different water sources over 48 hours with minimal reductions shows potential for application within an irrigation water system. However, based on these results, if the LAB were to be applied through the water irrigation route, the starting concentration is preferably increased by about 2 log CFU/ml to the range of between 5×10⁹ CFU/mL and 5×10¹¹ CFU/mL. This increased concentration helps maximize the effectiveness to a softer water type. The Lactiguard™ may be placed within the water irrigation reservoir prior to watering and still remain at a high enough concentration to effectively reduce E. coli O157:H7 and Salmonella.

### Example 6

### Survivability of Lactic Acid Producing Bacteria (LAB) in the Soil

To evaluate the survivability of the LAB strains such as Lactiguard™ in the soil, the strains were inoculated in sandy loam soil and incubated for over twenty-eight days in identical weather conditions. Within the soil study, time of application of the LAB was significant throughout the experiment (P<0.0001).

The total numbers of LAB were significantly reduced by about 3.0 logs CFU/g by the end of the study. The greatest loss was reported within the first week (P<0.02) and another 0.8 log CFU/g reduction was observed between days 21 and 28. The total amount of LAB recovered at sampling times of 0 hour, 6 hours and 3 days are significantly higher than the other time periods (P<0.05). The total amount of LAB recovered on days 7, 11, 14, and 21 were not significantly different (P>0.05) and days 11, 14, and 21 were not significantly different from each other (P>0.05). Based on these results, if the LAB were to be applied through the soil, the level of the LAB should preferably be increased by at least 2 log CFU/grams to a range of between about 5×10¹⁰ CFU/gram and 5×10¹¹ to maximize its full effectiveness against pathogenic microorganisms in the soil.

### Example 7

### Survivability of Lactic Acid Producing Bacteria (LAB) When Applied to Whole Spinach Plant

The objective of this experiment was to determine the behavior of LAB on the spinach plant when applied during the first four weeks of the growing cycle using three different methods; 1) watering 20 ml of Lactiguard™ at a concentration of 10¹⁰ CFU onto the plant, 2) electrostatically applying 20 ml of Lactiguard™ at a concentration of 10¹⁰ CFU onto the plant, and 3) electrostatically applying 20 ml of Lactiguard™ at a concentration of 10¹¹ CFU onto the plant.

When the Lactiguard™ was watered onto the spinach plants at a 10¹⁰ CFU/ml concentration, the total amount of LAB recovered at application time was significant for the composite samples, entire plant samples, leaf samples, and soil samples (P=0.0528, P=0.0901, P=0.0033, and P=0.0965, respectively). Among the four sample types, the total amount of LAB recovered for application at 4 weeks consistently yielded the highest LAB counts at the time of harvest. Although this was the most consistent application level to yield the highest LAB counts, when further analyzed, the amount of LAB between the different sample types was not consistent and yields were found between 3 to 6 logs CFU/ml, logs CFU/30 leaves or logs CFU/grams.

The total amount of LAB recovered at application time of electrostatically applied Lactiguard™ at a concentration of 10¹⁰ CFU/ml was not significant for composite samples (P=0.1148), however, application time was significant for the entire plant samples, leaf samples, and soil samples (P=0.0415, P=0.0770, and P=0.0067, respectively). Among the entire plant samples and leaf samples, the total amount of LAB recovered at week 4 along with the double application at planting and week 4 yielded significantly higher LAB counts consistently. For all sample types that had electrostatically applied Lactiguard™ at a concentration of 10¹⁰ CFU/ml upon harvest, the LAB counts were between 5 and 6 logs CFU/mL, logs CFU/30 leaves or logs CFU/grams.

When the Lactiguard™ was electrostatically applied to the spinach plant at a concentration of 10¹¹ CFU/ml, the composite samples, entire plant samples, leaf samples, and soil samples all had significant amounts of LAB recovered based on the LAB application period (P=0.0084, P=0.0022, P<0.0001, and P=0.0149, respectively). The total amount of LAB recovered at week 5, the double application at planting plus 3 weeks, and planting plus 4 weeks consistently were among the highest LAB numbers at harvest. For all sample types that had electrostatically applied Lactiguard™ at a concentration of 10¹¹ CFU/ml, the LAB counts were between 7 and 8 logs CFU/ml, logs CFU/30 leaves or logs CFU/grams at harvest.

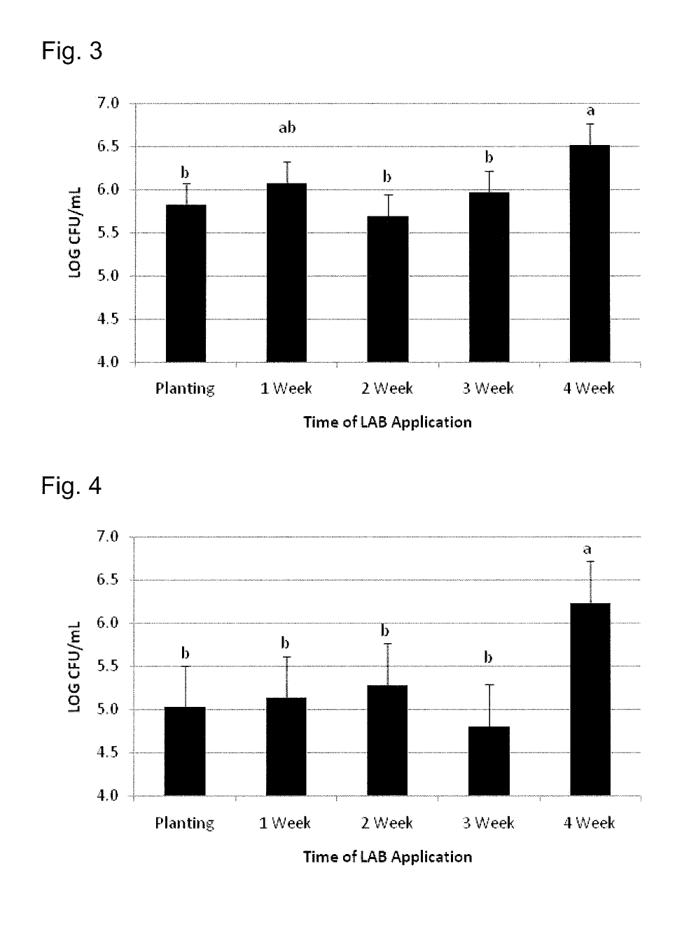

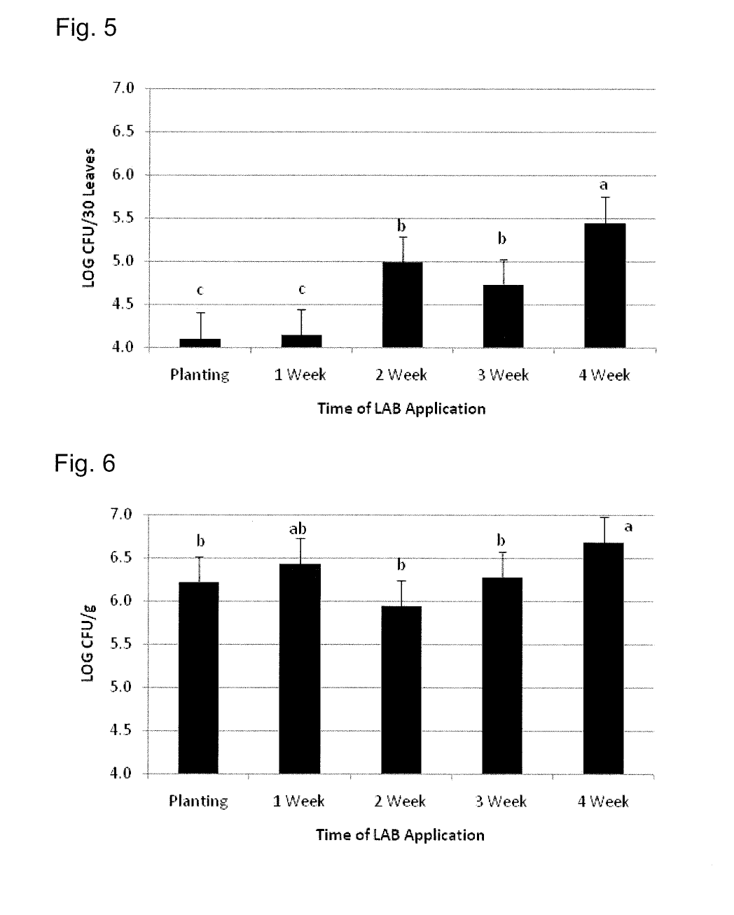

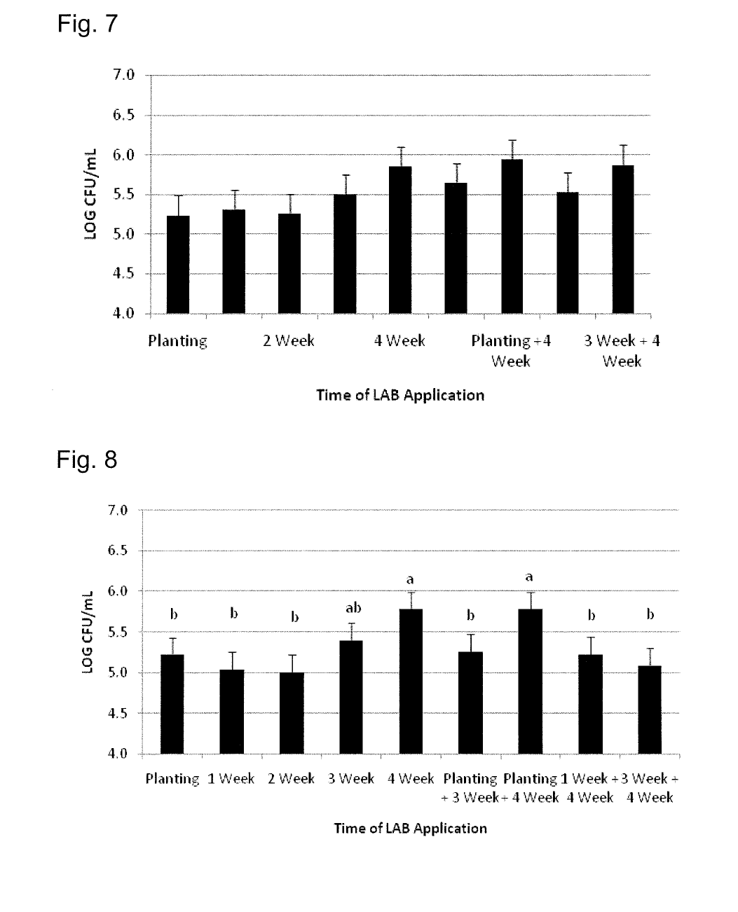

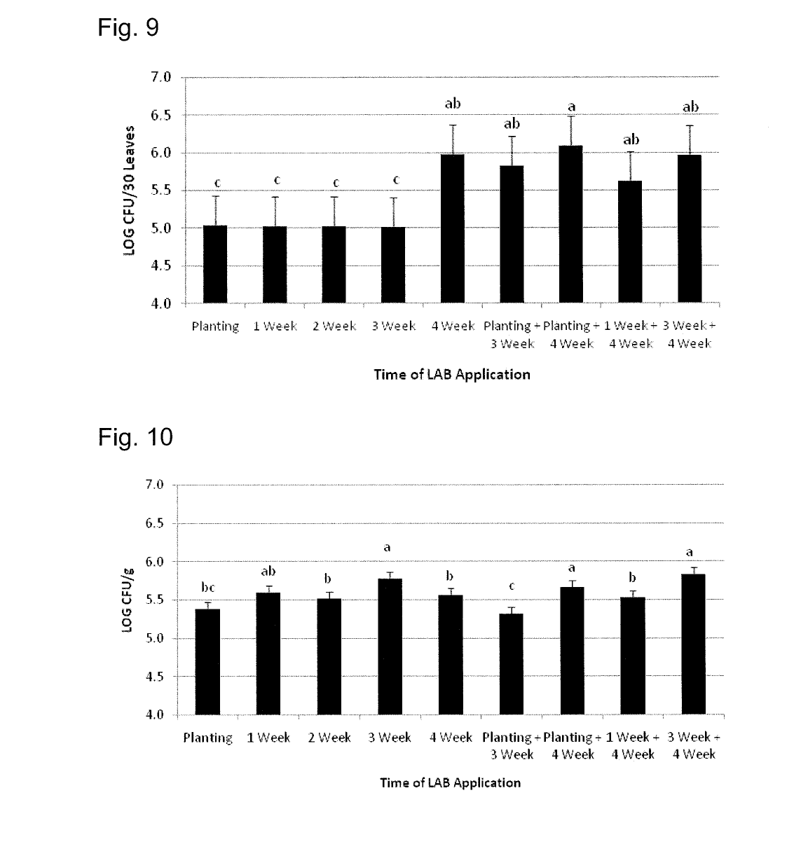

FIG. 3 shows the survivability of lactic acid bacteria within the composite sample at harvest when lactic acid bacteria at 10¹⁰ CFU/ml concentration was watered once onto spinach plants during the first four weeks of the growing cycle. Composite sample consist of thirty randomly picked whole leaves, twenty-five grams of randomly selected soil, and four randomly picked whole plants, which included all leaves, stems, roots, and any attached soil. FIG. 4 shows the survivability of lactic acid bacteria within the entire plant sample at harvest when lactic acid bacteria at 10¹⁰ CFU/ml concentration was watered once onto spinach plants during the first four weeks of the growing cycle. Entire samples consist of eight randomly picked whole plants, which included all leaves, stems, roots, and any attached soil. FIG. 5 shows the survivability of lactic acid bacteria within the leaf sample at harvest when lactic acid bacteria at 10¹⁰ CFU/ml concentration was watered once onto spinach plants during the first four weeks of the growing cycle. Leaf samples consist of thirty randomly picked whole leaves. FIG. 6 shows the survivability of lactic acid bacteria within the soil sample at harvest when lactic acid bacteria at 10¹⁰ CFU/ml concentration was watered once onto spinach plants during the first four weeks of the growing cycle. Soil samples consist of twenty-five grams of soil from the first 1.27 cm off the top of the soil. FIG. 7 shows the survivability of lactic acid bacteria within the composite sample at harvest when lactic acid bacteria at 10¹⁰ CFU/ml concentration was electrostatically sprayed once onto spinach plants during the first four weeks of the growing cycle. Composite sample consist of thirty randomly picked whole leaves, twenty-five grams of randomly selected soil, and four randomly picked whole plants, which included all leaves, stems, roots, and any attached soil. FIG. 8 shows the survivability of lactic acid bacteria within the entire plant sample at harvest when lactic acid bacteria at 10¹⁰ CFU/ml concentration was electrostatically sprayed once onto spinach plants during the first four weeks of the growing cycle. Entire samples consist of eight randomly picked whole plants, which included all leaves, stems, roots, and any attached soil. FIG. 9 shows the survivability of lactic acid bacteria within the leaf sample at harvest when lactic acid bacteria at 10¹⁰ CFU/ml concentration was electrostatically sprayed once onto spinach plants during the first four weeks of the growing cycle. Leaf samples consist of thirty randomly picked whole leaves. FIG. 10 shows the survivability of lactic acid bacteria within the soil sample at harvest when lactic acid bacteria at 10¹⁰ CFU/ml concentration was electrostatically sprayed once onto spinach plants during the first four weeks of the growing cycle. Soil samples consist of twenty-five grams of soil from the first 1.27 cm off the top of the soil.

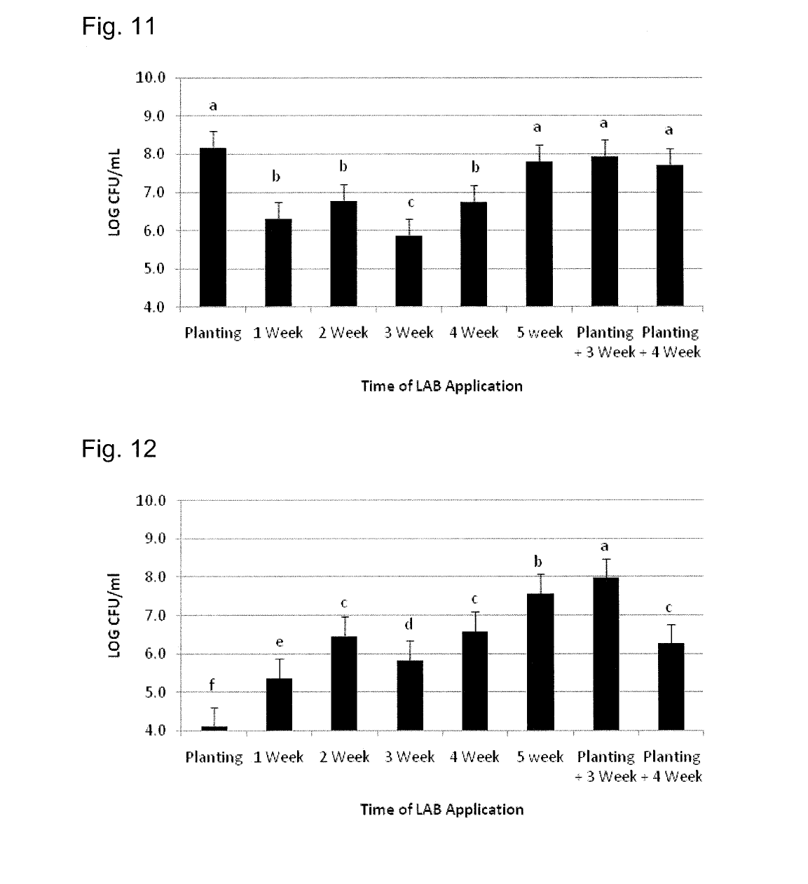

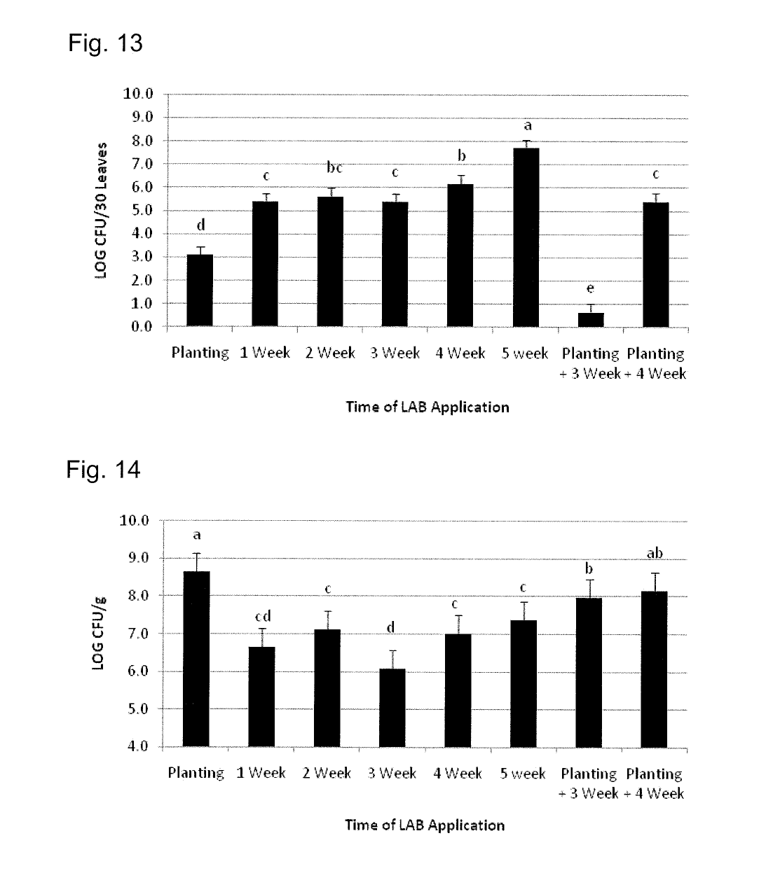

FIG. 11 shows the survivability of lactic acid bacteria within the composite sample at harvest when lactic acid bacteria at 10¹¹ CFU/ml concentration was electrostatically sprayed once onto spinach plants during the first four weeks of the growing cycle. Composite sample consist of thirty randomly picked whole leaves, twenty-five grams of randomly selected soil, and four randomly picked whole plants, which included all leaves, stems, roots, and any attached soil. FIG. 12 shows the survivability of lactic acid bacteria within the entire plant sample at harvest when lactic acid bacteria at 10¹¹ CFU/ml concentration was electrostatically sprayed once onto spinach plants during the first four weeks of the growing cycle. Entire samples consist of eight randomly picked whole plants, which included all leaves, stems, roots, and any attached soil. FIG. 13 shows the survivability of lactic acid bacteria within the leaf sample at harvest when lactic acid bacteria at 10¹¹ CFU/ml concentration was electrostatically sprayed once onto spinach plants during the first four weeks of the growing cycle. Leaf samples consist of thirty randomly picked whole leaves. FIG. 14 shows the survivability of lactic acid bacteria within the soil sample at harvest when lactic acid bacteria at 10¹¹ CFU/ml concentration was electrostatically sprayed once onto spinach plants during the first four weeks of the growing cycle. Soil samples consist of twenty-five grams of soil from the first 1.27 cm off the top of the soil.

Taking into account all the factors, a single application of Lactiguard™ at a higher initial concentration (10¹¹ CFU/ml) appeared to result in uniform distribution of the LAB on the spinach plant and might be more practical in an industry setting as compared to other methods. Based on the results of the three methods of LAB application onto the spinach plants, the electrostatically applied LAB at a concentration of 10¹¹ CFU/ml later in the growth cycle appeared to yield the highest LAB numbers upon harvest, which may help maximizing the benefits of the LAB against potential pathogens, and is thus the preferred methods for purpose of this disclosure.

### Example 8

### Materials and Methods for Reducing Pathogenic E. coli Contamination in Pre-Harvest Spinach

Spinach was grown within a plant growth chamber set to the weather conditions similar to that of the central California's fall season. Central California's fall growing conditions are as follows: Mornings: between 15-18° C. and 60-80% humidity; Afternoons: between 18-24° C. and 50-60% humidity: Nights: 17-22° C. and 55-70% humidity, and overnights 13-15° C. and humidity 70-86%.

“Emilia F1” spinach seeds were obtained from a California seed supplier and sandy loam soil was acquired from a local nursery. Sandy loam soil was a combination of black soil, sand and mulch (50%, 42.85%, and 7.15% respectively). Spinach plants were grown according to the following methods. Briefly, soil was loosened to ease the distribution of fertilizer prior to planting. 11-52 fertilizer (Western Farm Services, Fresco, Calif.) was spread on the soil at a rate of 400-500 lbs/acre. Fertilizer was mixed into the top 7.62 cm of the soil and the soil was compacted to ease the planting process. Seeds were planted at a depth of 0.635 cm with 0.3175 cm between seeds and each row 5.08 cm apart. Seeds were completely covered with soil and compacted for a smooth surface. Dual Magnum herbicide (Syngenta, Greenboro, N.C.) was sprayed onto the soil at a rate of 21.25 oz/acre using a backpack sprayer.

The plants were watered every two to three days in the morning, afternoon, and evening to saturation during the growing cycle. On Days 12 and 16 of the growing cycle, UN-32 fertilizer (Western Farm Services, Fresco, Calif.) was applied at a rate of 10 gal/acre. Three to eight days after the last irrigation the spinach plants should have been ready to harvest (week 4-5 post-planting). Typical harvesting occurred between the 5th and 6th week post-planting.

Conviron Environment Growth chamber with metal halide MH 400 bulbs in high intensity discharge lamps (SLI-USA, Metal halide MH400/U clear MOG ED37 high intensity bulbs, Mullins, S.C.) was utilized for this experiment at Texas Tech University (Cmp 5090, Model BDW120, Serial 050144, (800)363-6451, Pembina, N. Dak.). This growth chamber has the ability to control and monitor the temperature, humidity, light intensity, and carbon dioxide levels (Controlled Environments Limited 1996-2002 program). The chamber was set to typical central California growing conditions encountered between September and October. The settings were shown in Table 6, which were chosen based on weather records taken during the fall of 2008 and 2009.

TABLE 6
Growth Condition of Spinach

| Time | Temperature C. | Humidity % | Light |
|---|---|---|---|
| 12 am-4 am | 13 C. | 86 | No Light |
| 4 am-7 am | 12 C. | 80 | Lights going up |
| 7 am-9 am | 14 C. | 75 | Morning light |
| 9 am-12 pm | 18 C. | 60 | Full Light |
| 12 pm-4 pm | 24 C. | 46 | High Noon Light |
| 4 pm-7 pm | 22 C. | 55 | Full Light |
| 7 pm-9 pm | 17 C. | 61 | Evening light |
| 9 pm-12 am | 15 C. | 70 | No Light |

The E. coli O157:H7 inoculum consisted of four strains originally isolated by the University of Nebraska from cattle and are now stored in the Texas Tech University stock culture collection. These strains were chosen due to their ability to withstand cold conditions and survive in adverse environmental conditions. The inoculum was created by the following procedure. One vial of each strain was acquired from −80° C. storage and a 1.0 μl aliquot of each was collected using a sterile, disposable loop to inoculate separate tubes of Brain Heart Infusion Broth (BHI) (EMD, Gibbstown, N.J.) and incubated at 37° C. for 24 hours. Next, new BHI tubes were inoculated with 1 ml of growth from the original BHI inoculums and incubated at 37° C. for 24 hours. After the 24-hour incubation time, each strain was plated onto Tryptic Soy Agar (TSA) (EMD, Gibbstown, N.J.) and incubated again at 37° C. for 24 hours to determine the concentrations. After concentrations were determined, the four separate strains were combined in equal concentrations in BHI broth and incubated at 37° C. for 24 hours. The broth containing the combined culture was centrifuged at 4,000×g for 10 minutes and the pellet was re-suspended into sterile BHI with 10% glycerol. The four strain inoculum was then frozen and stored at −80° C. in 1 ml microcentrifuge tubes at a concentration of 1.0×10⁹ CFU/ml.

Lactiguard™ was used to formulate the LAB inoculums. Lactiguard™ is manufactured by Nutrition Physiology Corporation (Guymon, Okla.) and contains four LAB strains; Lactobacillus acidophilus, Lactobacillus cristpatus, Pediococcus acidilactici and Lactococcus lactis subsp. lactis. Lactobacillus acidophilus (NP51) and Lactobacillus cristpatus (NP 35) were originally isolated from cattle while Pediococcus acidilactici (NP 3) was isolated from cooked hot dogs and Lactococcus lactis subsp. lactis (NP 7) was obtained from alfalfa sprouts. See Smith, L., J. E. Mann, K. Harris, M. F. Miller, and M. M. Brashears. 2005. Reduction of Escherichia coli O157:H7 and Salmonella in ground beef using lactic acid bacteria and the impact on sensory properties. J. Food Prot. 68:1587-1592. This culture was prepared commercially and packaged in freeze-dried 10 gram portions with maltodextrin at a concentration of 10¹⁰ CFU/gram. The packets were stored in a −20° C. freezer until use.

Lactic Acid Bacteria and Escherichia coli Inoculation Procedure

One 10-gram Lactiguard™ packet was added to 90 ml of Lubbock municipal tap water and incubated at 37° C. for 24 hours to yield a final concentration of 10¹⁰ CFU/ml. Twenty milliliters of the inoculated tap water with the Lactiguard™ was electrostatically sprayed onto the soil/plant at specific time periods (planting, 1 week, 2 weeks, 3 weeks, or 4 weeks post planting) using a hand-held device created by Nutrition Physiology Company, LLC in the BSL2 pathogen lab facility. This hand-held device provided electrostatic pressure that charged the liquid droplets allowing the lactic acid bacteria to adhere onto the surface of the plant and soil. After application of the Lactiguard™ the plants were placed back into the growth chamber for the remaining duration of the growing cycle. Twenty-five spinach plants per pot were grown per replication within the growth chamber with 5 pots being assigned to each of the five different LAB treatment group. The 5 treatment Groups were: planting, 1 week, 2 weeks, 3 weeks, and 4 weeks post planting for a total of 5 different treatments. These 5 Groups differed in the timing of LAB treatment.

Each of the five pots within the same LAB treatment Group received the same Escherichia coli O157:H7 inoculum during the growing process at a different inoculation time. The plants were inoculated with E. coli O157:H7 under a biological safety hood located in the BSL2 microbiology laboratory by watering 20 ml of 10⁴⁵ CFU/ml of a 5-strain inoculum onto the plant at the specified time period, namely, planting, lweek, 2 weeks, 3 weeks, and 4 weeks post planting. The end concentration on the plant and soil was approximately 10³ CFU/g of plant or soil, respectively, which was calculated based on preliminary studies to ensure a uniform distribution of E. coli O157:H7 on the plant and soil, depending on the point of application in the spinach growing cycle. For the treatment pots that received the E. coli O157:H7 and LAB on the same day, for two of the replications E. coli O157:H7 was applied first in the morning (8am) and the LAB was applied second in the late afternoon (4 pm) and the other two replications LAB was applied first in the morning (8 am) and the E. coli O157:H7 was applied second in the late afternoon (4 pm).

Five additional pots were assigned to one of the application time periods, but did not receive any Lactiguard™ application, which acted as a control within this experiment. The plants remained under the biological safety hood for 30 minutes for attachment and then were transported back to the growth chamber for the duration of the study or until the time of LAB application to the plant. In summary, thirty pots of plants were grown within each replication, 25 receiving a Lactiguard™ and E. coli O157:H7 application and 5 receiving just an E. coli O157:H7 application (Control).

### Sampling Procedure

On harvest day, plants were placed in coolers and brought to the BSL2 microbiology laboratory for sampling. Each pot had 4 separate samples (composite, leaves, soil, and the entire plant) taken from it and the pot was then discarded into biohazard bins for proper disposal. The composite samples consisted of 30 randomly picked whole leaves, 25 grams of randomly selected soil, and 4 randomly picked whole plants, which included all leaves, stems, roots, and any attached soil. Appropriate amounts of buffered peptone water (Remel, Lenexa, Kans.) diluent was added depending on the sample weight, hand stomached for 1 minute and then serially 1:10 diluted.

The leaf samples were collected by randomly picking 30 whole leaves from the treatment pots. Appropriate amounts of buffered peptone water (BPW) diluent was added depending on the sample weight, stomached for 1 minute at 230 RPM (Stomacher 400, Seward Circular, England) and then serial 1:10 dilutions were performed.

The soil samples were gathered by randomly removing 25-g of soil from the first 1.27 cm off the top of the soil within each treatment pot. Two-hundred-fifty milliliters of BPW was added to the soil, hand stomached for 1 minute and serially diluted. The entire plant samples included eight full plants, which includes all leaves, stem, roots, and any attached soil, were pulled from each pot and combined into 1 sample bag. Appropriate amounts of BPW diluent was added depending on the sample weight, hand stomached for 1 minute and serial 1:10 dilutions were performed.

All serial dilutions were plated onto De Man, Regosa and Sharpe agar plates (Lactobacilli MRS/MRS) (EMD, Gibbstown, N.J.) and incubated at 37° C. for 48 hours and counted. E. coli O157:H7 was plated onto SD-39 agar with cefixime and tellurite plates (CT) (Neogen, Lansing, Mich.) and incubated at 44.5° C. for 24 hours. Bright pink or orange colonies were counted and enumerated as E. coli O157:H7. SD-39 with CT was determined in a separate experiment described below, which included 8 other agar and antibiotic combinations, to yield the most accurate detection and enumeration of E. coli O157:H7 while successfully repressing the high numbers of natural flora found on plants and in soil.

Media Selection for Escherichia coli O157:H7

SD-39 agar with cefixime tellurite (CT) was selected from eight different commonly utilized media for the enumeration and detection of E. coli O157:H7. In a bench top study, E. coli O157:H7 was inoculated onto 5-week old spinach leaves at a concentration of 10³ CFU/g. Thirty leaves along with appropriate amount of diluent were stomached for 2 minutes and then plated onto the following medium: MacConkey agar, MacConkey with CT agar, Sorbital MacConkey agar, Sorbital MacConkey with CT agar, Chromagar, Chromagar with CT, SD-39, and SD-39 with CT. The plates were incubated for the proper times and temperatures based on the agar type and the appropriate colonies were enumerated. As a result, SD-39 with CT was utilized because it allowed accurate enumeration with easy to distinguish colonies and suppressed high numbers of natural flora more successfully than the other media.

### Statistical Analysis

This study was categorized as a completely randomized design and the data was analyzed with the Statistical Analysis System (SAS) software. The PROC MIXED command was used due to an imbalance in the data. The least squares means were utilized to evaluate the effect of the treatments, which are a combination of LAB application and E. coli O157:H7 inoculation time. A significance level of 0.05 was applied in all tests and used to determine differences between experimental units, which were each individual spinach pot. Experimental units were completely randomized within treatments prior to applications. The experiment was repeated four times.

### Example 9

### Reduction of E. coli O157:H7 in Composite Samples

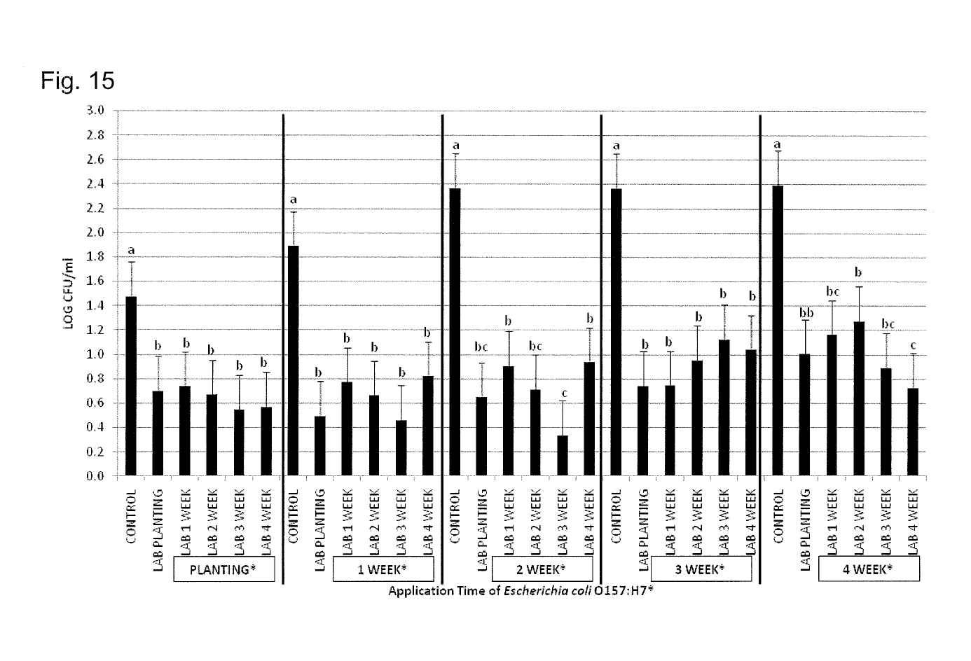

FIG. 15 describes the total numbers (log CFU/ml) of E. coli O157:H7 recovered at harvest time on the composite sample, which included 4 entire plants, 30 leaves, and 25 grams of soil sample, when Lactiguard™ was applied at one of the specific time points during the growing cycle. The figure is divided by the week/time point at which the E. coli O157:H7 was watered onto the plant and soil at a final concentration of 10³ CFU/g plant. The “controls” in this group were plants that received E. coli O157:H7 at one of the specific time points during the growing cycle, but did not receive the Lactiguard™

As shown in FIG. 15, when Escherichia coli O157:H7 contaminates the spinach plant at anytime between planting and the fourth week of the growing cycle and Lactiguard™ was electrostatically applied within the same time period, the E. coli O157:H7 numbers in the composite samples were significantly lower than the control plants that did not receive Lactiguard™ (P<0.05).

Specifically, when E. coli O157:H7 contaminated the spinach plant at 10³CFU during planting with no intervention (control), at harvest 1.5 log CFU/ml remained on the plant. When Lactiguard™ was applied once electrostatically to the spinach plant between planting and the fourth week of the growing cycle and the E. coli O157:H7 was applied at planting, between 0.5-0.7 log CFU/ml remained on the plant at harvest. These numbers indicated that a 0.8-1.0 log CFU/ml reduction in E. coli O157:H7 is expected when compared to the control plants (P<0.05). There was no significant difference in the amount of E. coli O157:H7 recovered on the spinach plant at harvest when E. coli O157:H7 was applied at planting and Lactiguard™ was applied electrostatically anytime between planting and the fourth week of the growing cycle (P>0.05) indicating that the Lactiguard™ should be applied earlier in the process for the most efficacy.

Plants contaminated with E. coli O157:H7 at 10³CFU/g at 1 week post planting with no intervention (control), retained 1.9 log CFU/ml on the plant at harvest. When Lactiguard™ was applied once electrostatically to the spinach plant between planting and the fourth week of the growing cycle and the E. coli O157:H7 was applied at 1 week post planting, between 0.5-0.8 log CFU/ml remained at harvest. These numbers indicated that a 1.1-1.4 log CFU/ml reduction in E. coli O157:H7 is expected when compared to the control plants (P<0.05). There was no significant difference in the amount of E. coli O157:H7 recovered on the spinach plant at harvest when E. coli O157:H7 was applied at 1 week post planting and Lactiguard™ was applied electrostatically anytime between planting and the fourth week of the growing cycle (P>0.05).

Plants contaminated with E. coli O157:H7 at 10³CFU/ml at 2 weeks post planting with no intervention (control), retained 2.4 logs CFU/ml on the plant at harvest. When Lactiguard™ was applied once electrostatically to the spinach plant between planting and the fourth week of the growing cycle and the E. coli O157:H7 was applied at 2 weeks post planting, between 0.3-0.9 log CFU/ml remained on the plant at harvest. These numbers indicate that a 1.5-2.1 log CFU/ml reduction in E. coli O157:H7 is expected when compared to the control plants (P<0.05). There was no significant difference in the amount of E. coli O157:H7 recovered on the spinach plant at harvest when E. coli O157:H7 was applied at 2 weeks post planting and Lactiguard™ was applied electrostatically at planting, 1 week, 2 weeks, and 4 weeks post planting (P>0.05). There was no significant difference in the amount of E. coli O157:H7 recovered on the plant at harvest when E. coli O157:H7 was applied at 2 weeks posts planting and Lactiguard™ was applied electrostatically at planting, 2 weeks, and 3 weeks post planting (P>0.05).

Plants contaminated with E. coli O157:H7 at 10³CFU/ml at 3 weeks post planting with no intervention (control), retained 2.4 logs CFU/ml on the plant at harvest. When Lactiguard™ was applied once electrostatically to the spinach plant between planting and the fourth week of the growing cycle and the E. coli O157:H7 was applied at 3 weeks post planting, between 0.7-1.1 log CFU/ml remained on the plant at harvest. These numbers indicate that a 1.3-1.7 log CFU/ml reduction in E. coli O157:H7 is expected when compared to the control plants (P<0.05). There was no significant difference in the amount of E. coli O157:H7 recovered on the spinach plant at harvest when E. coli O157:H7 was applied at 3 weeks post planting and Lactiguard™ was applied electrostatically anytime between planting and the fourth week of the growing cycle (P>0.05).

Plants contaminated with E. coli O157:H7 at 10³CFU/ml at 4 weeks post planting with no intervention (control), retained 2.4 logs CFU/ml on the plant at harvest. When Lactiguard™ was applied once electrostatically to the spinach plant between planting and the fourth week of the growing cycle and the E. coli O157:H7 was applied at 4 weeks post planting, between 0.7-1.3 log CFU/ml remained on the plant at harvest. These numbers indicated that a 1.1-1.7 log CFU/ml reduction in E. coli O157:H7 is expected when compared to the control plants (P<0.05). There was no significant difference in the amount of E. coli O157:H7 recovered on the spinach plant at harvest when E. coli O157:H7 was applied at 4 week posts planting and Lactiguard™ was applied electrostatically at planting, 1 week, 2 weeks, and 3 weeks post planting (P>0.05). There was no significant difference in the amount of E. coli O157:H7 recovered on the spinach plant at harvest when E. coli O157:H7 was applied at 4 weeks posts planting and Lactiguard™ was applied electrostatically at planting, 1 week, 3 weeks, and 4 weeks post planting (P>0.05).

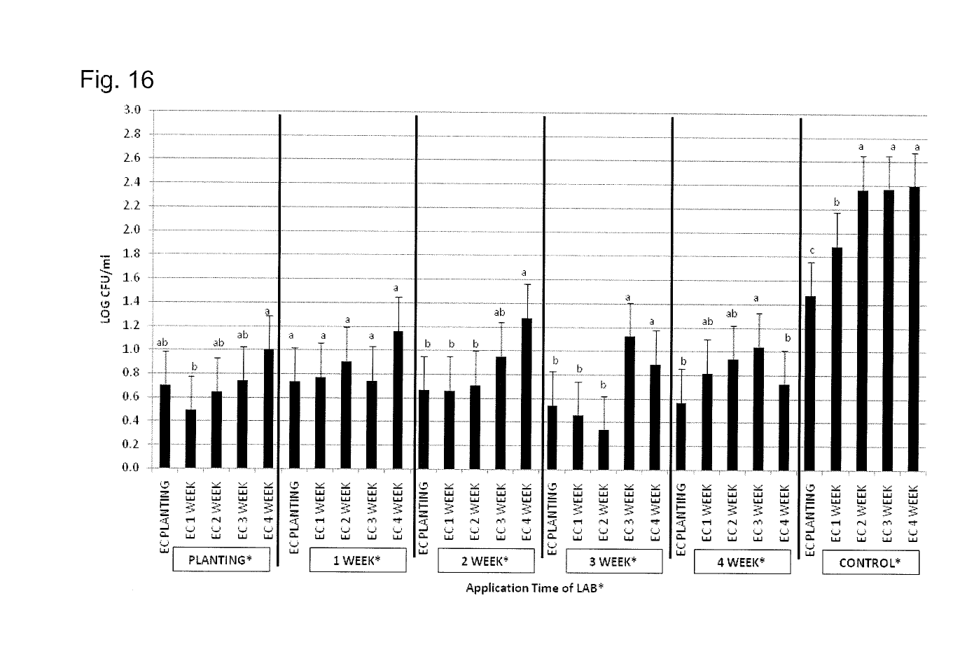

FIG. 16 describes the total numbers (log CFU/ml) of E. coli O157:H7 recovered at harvest time on the composite sample, which included 4 entire plants, 30 leaves, and 25-grams of soil sample, when Lactiguard™ is applied at one of the specific time points during the growing cycle. The figure is divided by the week/time point at which the Lactiguard™ was electrostatically applied onto the plant and soil at a final concentration of 10¹⁰ CFU/ml. The “controls” in this group are plants that received E. coli O157:H7 at one of the specific time points during the growing cycle, but did not receive the Lactiguard™.

Specifically, when Lactiguard™ was electrostatically applied to the spinach plant during the planting at 10¹⁰ CFU/ml and E. coli O157:H7 contaminated the plant between planting and the fourth week of the growing cycle, the recovered E. coli O157:H7 at harvest on the composite samples was between 0.5-1.0 log CFU/ml. There was no significant difference in the amount of E. coli O157:H7 recovered on the spinach plant at harvest when Lactiguard™ was electrostatically applied during planting and when E. coli O157:H7 was applied at planting, 1 week, 2 weeks, and 3 weeks post planting (P>0.05). There was no significant difference in the amount of E. coli O157:H7 recovered on the spinach plant at harvest when Lactiguard™ was electrostatically applied to the spinach plant during the planting, when E. coli O157:H7 was applied at planting, 2 weeks, 3 weeks, and 4 weeks post planting (P>0.05).

When Lactiguard™ was electrostatically applied to the spinach plant at 1 week post planting at 10¹⁰ CFU/ml and E. coli O157:H7 contaminated the plant between planting and the fourth week of the growing cycle, the recovered E. coli O157:H7 at harvest on the composite samples were between 0.7-1.2 log CFU/ml. There was no significant difference in the amount of E. coli O157:H7 recovered on the plant at harvest when Lactiguard™ was electrostatically applied to the spinach plant at 1 week post planting and when E. coli O157:H7 was applied anytime between planting and the fourth week of the growing cycle (P>0.05).

When Lactiguard™ was electrostatically applied to the spinach plant at 2 weeks post planting at 10¹⁰ CFU/ml and E. coli O157:H7 contaminated the plant between planting and the fourth week of the growing cycle, the recovered E. coli O157:H7 numbers at harvest on the composite samples were between 0.7-1.3 log CFU/ml. There was no significant difference in the amount of E. coli O157:H7 recovered on the plant at harvest when Lactiguard™ was electrostatically applied to the spinach plant at 2 weeks post planting, when E. coli O157:H7 was applied at planting, 1 week, 2 weeks, and 3 weeks post planting (P>0.05). There was no significant difference in the amount of E. coli O157:H7 recovered on the spinach plant at harvest when Lactiguard™ was electrostatically applied to the spinach plant at 2 weeks post planting when E. coli O157:H7 was applied at 3 weeks and 4 weeks post planting (P>0.05).

When Lactiguard™ was electrostatically applied to the spinach plant at 3 weeks post planting at 10¹⁰ CFU/ml and E. coli O157:H7 contaminated the plant between planting and the fourth week of the growing cycle, the recovered E. coli O157:H7 numbers at harvest on the composite samples were between 0.3-1.1 log CFU/ml. There was no significant difference in the amount of E. coli O157:H7 recovered on the spinach plant at harvest when Lactiguard™ was electrostatically applied to the spinach plant at 3 weeks post planting, when E. coli O157:H7 was applied at planting, 1 week, and 2 weeks post planting (P>0.05). There was no significant difference in the amount of E. coli O157:H7 recovered on the spinach plant at harvest when Lactiguard™ was electrostatically applied to the spinach plant at 3 weeks post planting, when E. coli O157:H7 was applied at 3 weeks and 4 weeks post planting (P>0.05).

When Lactiguard™ was electrostatically applied to the spinach plant at 4 weeks post planting at 10¹⁰ CFU/ml and E. coli O157:H7 contaminated the plant between planting and the fourth week of the growing cycle, the recovered E. coli O157:H7 numbers at harvest on the composite samples were between 0.6-1.0 log CFU/ml. There was no significant difference in the amount of E. coli O157:H7 recovered on the spinach plant at harvest when Lactiguard™ was electrostatically applied to the spinach plant at 4 weeks post planting, when E. coli O157:H7 was applied at planting, 1 week, 2 weeks and 4 weeks post planting (P>0.05). There was no significant difference in the amount of E. coli O157:H7 recovered on the spinach plant at harvest when Lactiguard™ was electrostatically applied to the spinach plant at 1 week post planting, when E. coli O157:H7 was applied at 1 week, 2 weeks and 3 weeks post planting (P>0.05).

When Lactiguard™ was not applied to the spinach plant and E. coli O157:H7 contaminated the plant between planting and the fourth week of the growing cycle, the recovered E. coli O157:H7 numbers at harvest on the composite samples were between 0.5-2.4 log CFU/ml. There was no significant difference in the amount of E. coli O157:H7 recovered on the spinach plant at 2 weeks, 3 weeks and 4 weeks post planting (P>0.05). There were significantly lower amounts of E. coli O157:H7 recovered when contamination occurred during planting and the first week post planting (P<0.001) when compared to 2 weeks, 3 weeks, and 4 weeks post planting (all P<0.05).

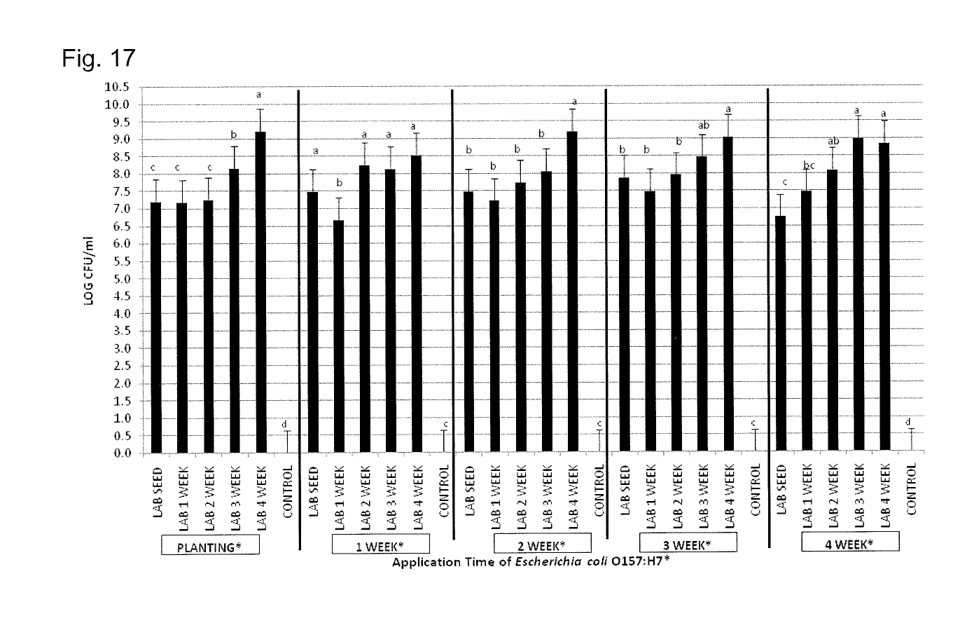

FIG. 17 describes the total numbers (log CFU/ml) of lactic acid bacteria recovered at harvest time on the composite sample, which consisted of 4 entire plants, 30 leaves, and 25-grams of soil sample, when E. coli O157:H7 is applied at one of the specific time points during the growing cycle. The figure is divided by the week/time point at which the E. coli O157:H7 was watered onto the plant and soil at a final concentration of 103 CFU/ml. The “controls” in this group are the plants that received E. coli O157:H7 at one of the specific time points during the growing cycle, but did not receive an application of Lactiguard™.

When E. coli O157:H7 contaminated the spinach plant at 10³ CFU/ml during planting, the lactic acid bacteria remained between 7.2-9.2 log CFU/ml at harvest when Lactiguard™ was electrostatically applied between planting and the fourth week of the growing cycle (FIG. 17). There was no significant difference in the amount of lactic acid bacteria recovered on the spinach plant at harvest when E. coli O157:H7 was applied at planting and Lactiguard™ was applied electrostatically at planting, 1 week, 2 weeks, and 3 weeks post planting (P>0.05). When E. coli O157:H7 contaminated the plant during planting and Lactiguard™ was applied at 3 weeks and 4 weeks post planting, significantly more lactic acid bacteria was recovered at harvest when compared to application at planting, 1 week, and 2 weeks post planting (P<0.05).

When E. coli O157:H7 contaminated the spinach plant at 10³ CFU/ml at 1 week post planting, the lactic acid bacteria remained between 6.7-8.5 log CFU/ml at harvest when Lactiguard™ was electrostatically applied between planting and the fourth week of the growing cycle (FIG. 17). There was no significant difference in the amount of lactic acid bacteria recovered on the spinach plant at harvest when E. coli O157:H7 was applied at 1 week post planting and Lactiguard™ was applied electrostatically at planting, 2 weeks, 3 weeks, and 4 weeks post planting (P>0.05). When E. coli O157:H7 contaminated the plant at 1 week post planting and Lactiguard™ was applied at 1 week, significantly less lactic acid bacteria was recovered at harvest when compared to application at planting, 2 weeks, 3 weeks and 4 weeks post planting (P<0.05).

When E. coli O157:H7 contaminated the spinach plant at 10³ CFU/ml at 2 weeks post planting, the lactic acid bacteria remained between 7.2-9.2 log CFU/ml at harvest when Lactiguard™ was electrostatically applied between planting and the fourth week of the growing cycle (FIG. 17). There was no significant difference in the amount of lactic acid bacteria recovered on the spinach plant at harvest when E. coli O157:H7 was applied at 2 weeks post planting and Lactiguard™ was applied electrostatically at planting, 1 week, 2 weeks, and 3 weeks post planting (P>0.05). When E. coli O157:H7 contaminated the plant at 2 weeks post planting and Lactiguard™ was applied at 4 weeks, significantly more lactic acid bacteria was recovered when compared to application at planting, 1 week, 2 weeks and 3 weeks post planting (P<0.05).

When E. coli O157:H7 contaminated the spinach plant at 10³ CFU/ml at 3 weeks post planting, the lactic acid bacteria remained between 7.5-9.0 log CFU/ml at harvest when Lactiguard™ was electrostatically applied between planting and the fourth week of the growing cycle (FIG. 17). There was no significant difference in the amount of lactic acid bacteria recovered on the spinach plant at harvest when E. coli O157:H7 was applied at 3 weeks post planting and Lactiguard™ was applied electrostatically at planting, 1 week, 2 weeks, and 3 weeks post planting (P>0.05). There was no significant difference in the amount of lactic acid bacteria recovered on the spinach plant at harvest when E. coli O157:H7 was applied at 3 weeks post planting and Lactiguard™ was applied electrostatically at 3 weeks and 4 weeks post planting (P>0.05). When E. coli O157:H7 contaminated the plant at 3 weeks post planting and Lactiguard™ was applied at 4 weeks, significantly more lactic acid bacteria was recovered at harvest when compared to application at planting, 1 week, and 2 weeks post planting (P<0.05).

When E. coli O157:H7 contaminated the spinach plant at 10³ CFU/ml at 4 weeks post planting, the lactic acid bacteria remained between 6.7-9.0 log CFU/ml at harvest when Lactiguard™ was electrostatically applied between planting and the fourth week of the growing cycle (FIG. 17). There was no significant difference in the amount of lactic acid bacteria recovered on the spinach plant at harvest when E. coli O157:H7 was applied at 4 weeks post planting and Lactiguard™ was applied electrostatically at planting, 1 week, and 2 weeks post planting (P>0.05). There was no significant difference in the amount of lactic acid bacteria recovered on the spinach plant at harvest when E. coli O157:H7 was applied at 4 weeks post planting and Lactiguard™ was applied electrostatically at 1 week and 2 weeks post planting (P>0.05). There was no significant difference in the amount of lactic acid bacteria recovered on the spinach plant at harvest when E. coli O157:H7 was applied at 4 weeks post planting and Lactiguard™ was applied electrostatically at 2 weeks, 3 weeks and 4 weeks post planting (P>0.05). When E. coli O157:H7 contaminated the plant at 4 weeks post planting and Lactiguard™ was applied at 3 weeks and 4 weeks, significantly more lactic acid bacteria was recovered at harvest when compared to application at planting and 1 week post planting (P<0.05).

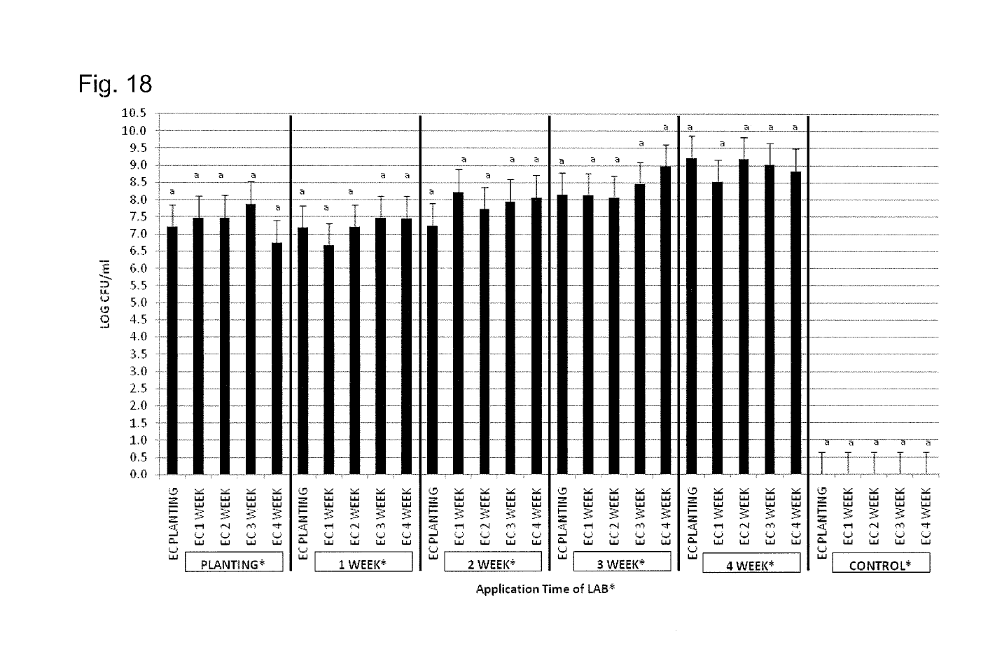

FIG. 18 describes the total numbers (log CFU/ml) of lactic acid bacteria recovered at harvest time on the composite sample, which included 4 entire plants, 30 leaves, and 25 grams of soil sample, when E. coli O157:H7 is applied at one of the specific time points during the growing cycle. The figure is divided by the week/time point at which the Lactiguard™ was electrostatically applied onto the plant and soil at a final concentration of 10¹⁰ CFU/ml. The “controls” in this group are plants that received E. coli O157:H7 at one of the specific time points during the growing cycle, but did not receive an application of Lactiguard™.

There was no significant differences among the total numbers of lactic acid bacteria recovered on the composite samples at harvest, regardless of the timing of E. coli O157:H7 contamination or the timing of when Lactiguard™ was electrostatically applied to the spinach plant (P>0.05).

### Example 10

### Reduction of E. coli O157:H7 in Leaf Samples

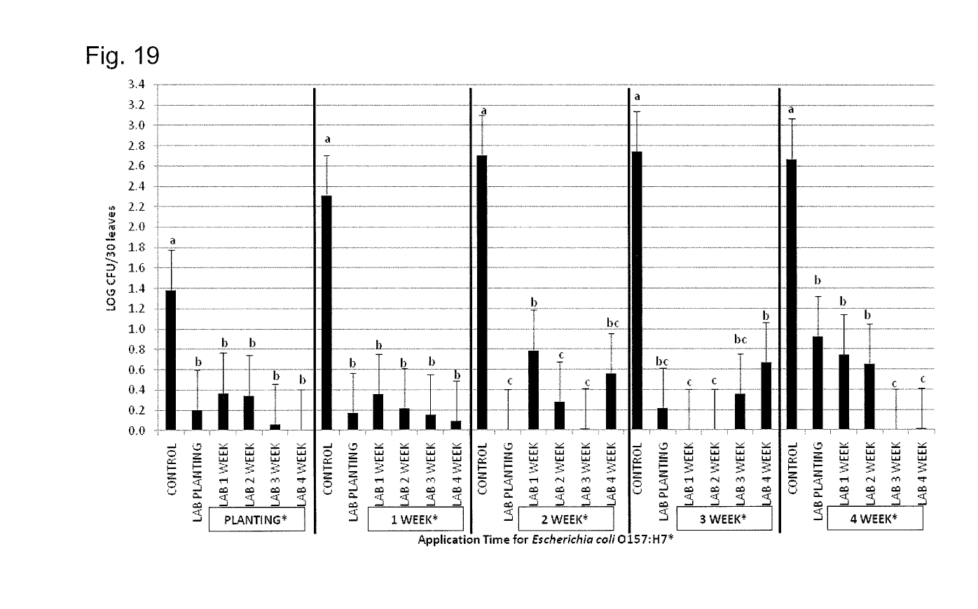

FIG. 19 describes the total numbers (log CFU/30 leaves) of E. coli O157:H7 recovered at harvest time on the leaf sample, which included 30 randomly selected leaves, when Lactiguard™ was electrostatically applied at one of the specific time points during the growing cycle. The figure is divided by the week/time point at which the E. coli O157:H7 was watered onto the plant and soil at a final concentration of 10³ CFU/ml. The “controls” in this group are plants that received E. coli O157:H7 at one of the specific time points during the growing cycle, but did not receive the Lactiguard™.

Within the leaf samples (FIG. 19), when Escherichia coli O157:H7 contaminates the spinach plant at anytime between planting and the fourth week of the growing cycle and Lactiguard™ was electrostatically applied within the same time period, the numbers of E. coli O157:H7 were significantly lower than those of the control plants which did not receive Lactiguard™ at harvest (P<0.05).

When E. coli O157:H7 contaminated the spinach plant at 10³ CFU/ml during planting with no intervention (control), 1.4 log CFU/30 leaves remained on the leaves at harvest. When Lactiguard™ was applied electrostatically to the spinach plant between planting and the fourth week of the growing cycle when the E. coli O157:H7 was applied at planting, between 0.0-0.4 log CFU/30 leaves remained on the leaves. These numbers indicated that a 1.0-1.4 log CFU/30 leaves reduction in E. coli O157:H7 is expected when compared to the control plants (P<0.05). There was no significant difference in the amount of E. coli O157:H7 recovered on the leaves at harvest when E. coli O157:H7 was applied at planting and Lactiguard™ was applied electrostatically anytime between planting and the fourth week of the growing cycle (P>0.05).

Plants contaminated with E. coli O157:H7 at 10³ CFU/ml at 1 week post planting with no intervention (control), retained 2.3 log CFU/30 leaves on the leaves at harvest. When Lactiguard™ was applied once electrostatically to the spinach plant between planting and the fourth week of the growing cycle and the E. coli O157:H7 was applied at 1 week post planting, between 0.1-0.4 log CFU/30 leaves remained on the leaves at harvest. These numbers indicated that a 1.9-2.1 log CFU/30 leaves reduction in E. coli O157:H7 is expected when compared to the control plants (P<0.05). There was no significant difference in the amount of E. coli O157:H7 recovered on the leaves at harvest when E. coli O157:H7 was applied at 1 week post planting and Lactiguard™ was applied electrostatically anytime between planting and the fourth week of the growing cycle (P>0.05).

Plants contaminated with E. coli O157:H7 at 10³ CFU/ml at 2 weeks post planting with no intervention (control), retained 2.7 log CFU/30 leaves on the leaves at harvest. When Lactiguard™ was applied electrostatically to the spinach plant between planting and the fourth week of the growing cycle and the E. coli O157:H7 was applied at 2 weeks post planting, between 0.0-0.8 log CFU/30 leaves remained on the leaves at harvest. These numbers indicated that a 1.9-2.7 log CFU/30 leaves reduction in E. coli O157:H7 is expected when compared to the control plants (P<0.05). There was no significant difference in the amount of E. coli O157:H7 recovered on the leaves at harvest when E. coli O157:H7 was applied at 2 weeks posts planting and Lactiguard™ was applied electrostatically at planting, 2 weeks, 3 weeks, and 4 weeks post planting (P>0.05). There was no significant difference in the amount of E. coli O157:H7 recovered on the leaves at harvest when E. coli O157:H7 was applied at 2 weeks posts planting and Lactiguard™ was applied electrostatically at 2 weeks and 4 weeks post planting (P>0.05).

Plants contaminated with E. coli O157:H7 at 10³ CFU/ml at 3 weeks post planting with no intervention (control), retained 2.7 log CFU/30 leaves on the leaves at harvest. When Lactiguard™ was applied electrostatically to the spinach plant between planting and the fourth week of the growing cycle and the E. coli O157:H7 was applied at 3 weeks post planting, between 0.0-0.7 log CFU/30 leaves remained on the leaves at harvest. These numbers indicated that a 2.0-2.7 log CFU/30 leaves reduction in E. coli O157:H7 is expected when compared to the control plants (P<0.05). There was no significant difference in the amount of E. coli O157:H7 recovered on the leaves at harvest when E. coli O157:H7 was applied at 3 weeks post planting and Lactiguard™ was applied electrostatically at planting, 1 week, 2 weeks, and 3 weeks post planting (P>0.05). There was no significant difference in the amount of E. coli O157:H7 recovered on the leaves at harvest when E. coli O157:H7 was applied at 3 weeks post planting and Lactiguard™ was applied electrostatically at planting, 3 weeks, and 4 weeks post planting (P>0.05).

Plants contaminated with E. coli O157:H7 at 10³ CFU/ml at 4 weeks post planting with no intervention (control), retained 2.7 log CFU/30 leaves on the leaves at harvest. When Lactiguard™ was applied electrostatically to the spinach plant between planting and the fourth week of the growing cycle when the E. coli O157:H7 was applied at 4 weeks post planting, between 0.0-0.7 log CFU/30 leaves remained on the leaves at harvest. These numbers indicated that a 1.6-2.7 log CFU/30 leaves reduction in E. coli O157:H7 is expected when compared to the control plants (P<0.05). There was no significant difference in the amount of E. coli O157:H7 recovered on the leaves at harvest when E. coli O157:H7 was applied at 4 weeks post planting and Lactiguard™ was applied electrostatically at planting, 1 week, and 2 weeks post planting (P>0.05). There was no significant difference in the amount of E. coli O157:H7 recovered on the leaves at harvest when E. coli O157:H7 was applied at 4 weeks post planting and Lactiguard™ was applied electrostatically at 3 weeks and 4 weeks post planting (P>0.05).

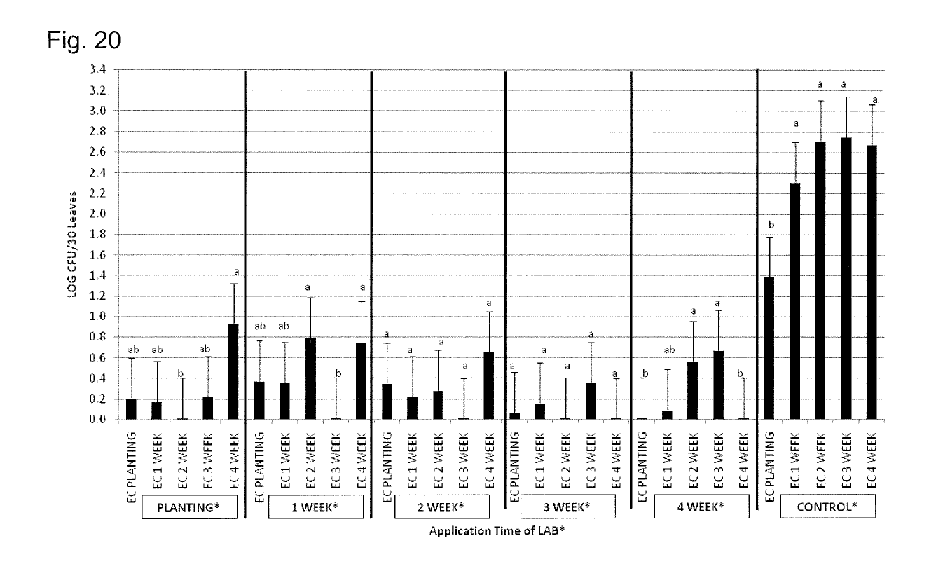

FIG. 20 describes the total numbers (log CFU/30 leaves) of E. coli O157:H7 recovered at harvest time on leaf samples, which included 30 randomly selected leaves, when Lactiguard™ is applied at one of the specific time points during the growing cycle. The figure is divided by the week/time point at which the Lactiguard™ was electrostatically applied onto the plant and soil at a final concentration of 10¹⁰ CFU/ml. The “controls” in this group are plants that received E. coli O157:H7 at one of the specific time points during the growing cycle, but did not receive the Lactiguard™.

When Lactiguard™ was electrostatically applied to the spinach plant during planting at 10¹⁰ CFU/ml and E. coli O157:H7 contaminated the plant between planting and the fourth week of the growing cycle, the recovered E. coli O157:H7 at harvest on the leaf samples were between 0.0-0.9 log CFU/30 leaves. There was no significant difference in the amount of E. coli O157:H7 recovered on the leaves at harvest when Lactiguard™ was electrostatically applied to the spinach plant during the planting, when E. coli O157:H7 was applied at planting, 1 week, 2 weeks, and 3 weeks post planting (P>0.05). There was no significant difference in the amount of E. coli O157:H7 recovered on the leaves at harvest when Lactiguard™ was electrostatically applied to the spinach plant during the planting, when E. coli O157:H7 was applied at 3 weeks and 4 weeks post planting (P>0.05).

When Lactiguard™ was electrostatically applied to the spinach plant at 1 week post planting at 10¹⁰ CFU/ml and E. coli O157:H7 contaminated the plant between planting and the fourth week of the growing cycle, the recovered E. coli O157:H7 at harvest on the leaf samples were between 0.0-0.8 log CFU/30 leaves. There was no significant difference in the amount of E. coli O157:H7 recovered on the leaves at harvest when Lactiguard™ was electrostatically applied to the spinach plant at 1 week post planting, when E. coli O157:H7 was applied at planting, 1 week, 2 weeks, and 4 weeks post planting (P>0.05). There was no significant difference in the amount of E. coli O157:H7 recovered on the leaves at harvest when Lactiguard™ was electrostatically applied to the spinach plant at 1 week post planting, when E. coli O157:H7 was applied at planting, 1 week, and 3 weeks post planting (P>0.05).

When Lactiguard™ was electrostatically applied to the spinach plant at 2 weeks post planting at 10¹⁰ CFU/ml and E. coli O157:H7 contaminated the plant between planting and the fourth week of the growing cycle, the recovered E. coli O157:H7 numbers at harvest on the leaf samples were between 0.0-0.7 log CFU/30 leaves. There was no significant difference in the amount of E. coli O157:H7 recovered on the leaves at harvest when Lactiguard™ was electrostatically applied to the spinach plant at 2 weeks post planting, when E. coli O157:H7 was applied at planting, 1 week, 2 weeks, and 3 weeks post planting (P>0.05). There was no significant difference in the amount of E. coli O157:H7 recovered on the leaves at harvest when Lactiguard™ was electrostatically applied to the spinach plant at 2 weeks post planting, when E. coli O157:H7 was applied between planting and the fourth week of the growing cycle (P>0.05).

When Lactiguard™ was electrostatically applied to the spinach plant at 3 weeks post planting at 10¹⁰ CFU/ml and E. coli O157:H7 contaminated the plant between planting and the fourth week of the growing cycle, the recovered E. coli O157:H7 at harvest on the leaf samples were between 0.0-0.4 log CFU/30 leaves. There was no significant difference in the amount of E. coli O157:H7 recovered on the leaves at harvest when Lactiguard™ was electrostatically applied to the spinach plant at 3 weeks post planting, when E. coli O157:H7 was applied at planting, 1 week, and 2 weeks post planting (P>0.05). There was no significant difference in the amount of E. coli O157:H7 recovered on the leaves at harvest when Lactiguard™ was electrostatically applied anytime between planting and the fourth week of the growing cycle (P>0.05).

When Lactiguard™ was electrostatically applied to the spinach plant at 4 weeks post planting at 10¹⁰ CFU/ml and E. coli O157:H7 contaminated the plant between planting and the fourth week of the growing cycle, the recovered E. coli O157:H7 at harvest on the leaf samples were between 0.0-0.7 log CFU/30 leaves. There was no significant difference in the amount of E. coli O157:H7 recovered on the leaves at harvest when Lactiguard™ was electrostatically applied to the spinach plant at 4 weeks post planting, when E. coli O157:H7 was applied at planting, 1 week, and 4 weeks post planting (P>0.05). There was no significant difference in the amount of E. coli O157:H7 recovered on the leaves at harvest when Lactiguard™ was electrostatically applied to the spinach plant at 1 week post planting, when E. coli O157:H7 was applied at 1 week, 2 weeks and 3 weeks post planting (P>0.05).

When Lactiguard™ was not applied to the spinach plant and E. coli O157:H7 contaminated the plant between planting and the fourth week of the growing cycle, the recovered E. coli O157:H7 at harvest on the leaf samples were between 1.4-2.7 logs CFU/30 leaves. There was no significant difference in the amount of E. coli O157:H7 recovered on the leaves at 1 week, 2 weeks, 3 weeks and 4 weeks post planting at harvest (P>0.05). There were significantly lower amounts of E. coli O157:H7 recovered on the leaves at harvest when contamination occurred during planting (P<0.001), when compared to 1 week, 2 weeks, 3 weeks, and 4 weeks post planting (all P<0.05).

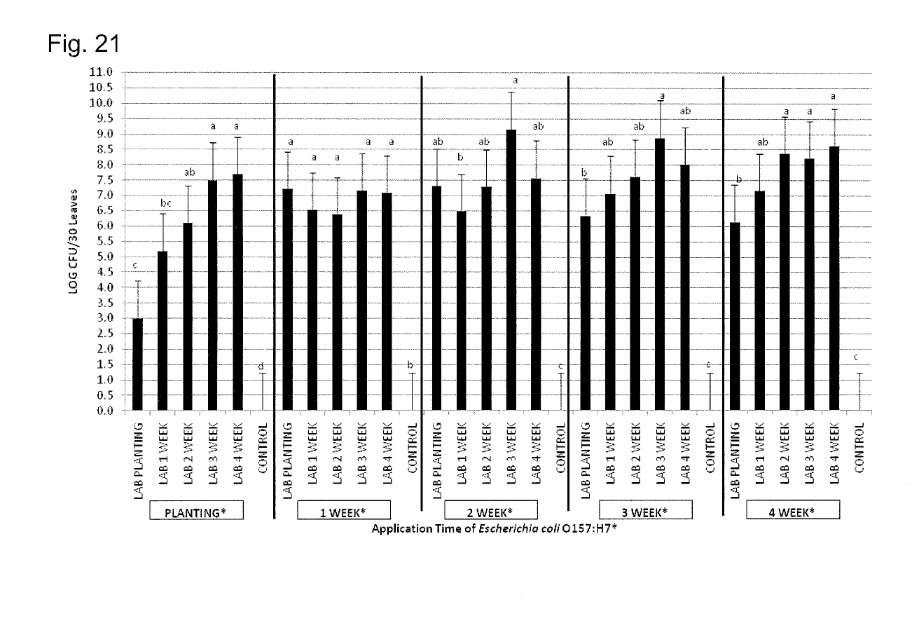

FIG. 21 describes the total numbers (log CFU/30 leaves) of lactic acid bacteria recovered at harvest time on the leaf sample, which included 30 randomly selected leaves, when E. coli O157:H7 was applied at one of the specific time points during the growing cycle. The figure is divided by the week/time point at which the E. coli O157:H7 was watered onto the plant and soil at a final concentration of 10³ CFU/ml. The “controls” in this group is plants that received E. coli O157:H7 at one of the specific time points during the growing cycle, but did not receive an application of Lactiguard™.

When E. coli O157:H7 contaminated the spinach plant at 10³ CFU/ml during planting, the lactic acid bacteria remained between 3.0-7.7 log CFU/30 leaves at harvest when Lactiguard™ was electrostatically applied between planting and the fourth week of the growing cycle (FIG. 21). There was no significant difference in the amount of lactic acid bacteria recovered on the leaves at harvest when E. coli O157:H7 was applied at planting and Lactiguard™ was applied electrostatically at planting and 1 week post planting (P>0.05). There was no significant difference in the amount of lactic acid bacteria recovered on the leaves at harvest when E. coli O157:H7 was applied at planting and Lactiguard™ was applied electrostatically at 2 weeks, 3 weeks, and 4 weeks post planting (P>0.05). When E. coli O157:H7 contaminated the plant during planting and Lactiguard™ was applied at 2 weeks, 3 weeks and 4 weeks post planting, significantly more lactic acid bacteria was recovered on the leaves at harvest when compared to application during planting (P<0.05).

When E. coli O157:H7 contaminated the spinach plant at 10³ CFU/ml at 1 week post planting, the lactic acid bacteria remained between 6.4-7.2 log CFU/30 leaves at harvest on the leaves when Lactiguard™ was electrostatically applied between planting and the fourth week of the growing cycle (FIG. 21). There was no significant difference in the amount of lactic acid bacteria recovered on the leaves at harvest when E. coli O157:H7 was applied at 1 week post planting and Lactiguard™ was applied electrostatically anytime during the first four weeks of planting (P>0.05).

When E. coli O157:H7 contaminated the spinach plant at 10³ CFU/ml at 2 weeks post planting, the lactic acid bacteria remained between 6.5-9.2 log CFU/30 leaves at harvest when Lactiguard™ was electrostatically applied between planting and the fourth week of the growing cycle (FIG. 21). There was no significant difference in the amount of lactic acid bacteria recovered on the leaves at harvest when E. coli O157:H7 was applied at 2 weeks post planting and Lactiguard™ was applied electrostatically at planting, 1 week, 2 weeks, and 4 weeks post planting (P>0.05). There was no significant difference in the amount of lactic acid bacteria recovered on the leaves at harvest when E. coli O157:H7 was applied at 2 weeks post planting and Lactiguard™ was applied electrostatically at planting, 2 weeks, 3 weeks, and 4 weeks post planting (P>0.05). When E. coli O157:H7 contaminated the spinach plant at 103 CFU/ml at 3 weeks post planting, the lactic acid bacteria remained between 6.3-8.9 log CFU/30 leaves at harvest when Lactiguard™ was electrostatically applied between planting and the fourth week of the growing cycle (FIG. 21). There was no significant difference in the amount of lactic acid bacteria recovered on the leaves at harvest when E. coli O157:H7 was applied at 3 weeks post planting and Lactiguard™ was applied electrostatically at planting, 1 week, 2 weeks, and 4 weeks post planting (P>0.05). There was no significant difference in the amount of lactic acid bacteria recovered on the leaves at harvest when E. coli O157:H7 was applied at 3 weeks post planting and Lactiguard™ was applied electrostatically at 1 week, 2 weeks, 3 weeks and 4 weeks post planting (P>0.05).

When E. coli O157:H7 contaminated the spinach plant at 10³ CFU/ml at 4 weeks post planting, the lactic acid bacteria remained between 6.1-8.6 log CFU/30 leaves at harvest when Lactiguard™ was electrostatically applied between planting and the fourth week of the growing cycle (FIG. 21). There was no significant difference in the amount of lactic acid bacteria recovered on the leaves at harvest when E. coli O157:H7 was applied at 4 weeks post planting and Lactiguard™ was applied electrostatically at planting and 1 week post planting (P>0.05). There was no significant difference in the amount of lactic acid bacteria recovered on the leaves at harvest when E. coli O157:H7 was applied at 4 weeks post planting and Lactiguard™ was applied electrostatically between the first and fourth weeks post planting (P>0.05).

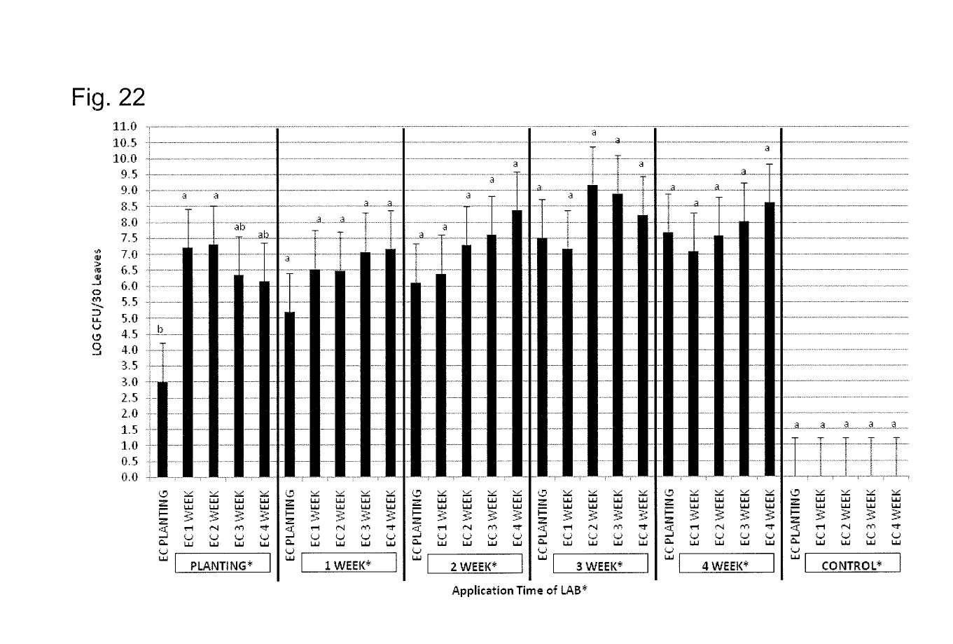

FIG. 22 describes the total numbers (log CFU/30 leaves) of lactic acid bacteria recovered at harvest time on the leaf sample, which consists of 30 randomly selected leaves, when E. coli O157:H7 is applied at one of the specific time points during the growing cycle. The figure is divided by the week/time point at which the Lactiguard™ was electrostatically applied onto the plant and soil at a final concentration of 1010 CFU/ml. The “controls” in this group is plants that received E. coli O157:H7 at one of the specific time points during the growing cycle, but did not receive an application of Lactiguard™.

There was a low level of lactic acid bacteria reported (3.0 log CFU/30 leaves) with E. coli O157:H7 applied at planting and Lactiguard™ applied at planting, which created differences between plants that received Lactiguard™ at planting and E. coli O157:H7 at different time points. When this point was removed from the data set, there was no significant differences among the total numbers of LAB recovered on the leaf samples, regardless of E. coli O157:H7 time of contamination or the time point Lactiguard™ was electrostatically applied to the spinach plant (P>0.05).

### Example 11

### Reduction of E. coli O157:H7 in Soil Samples

E. coli O157:H7 recovery at harvest

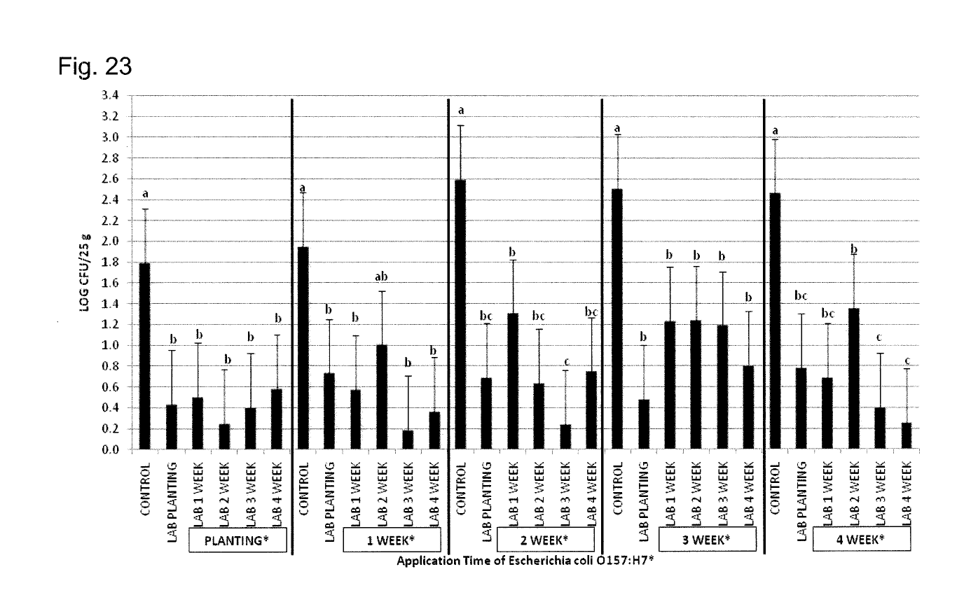

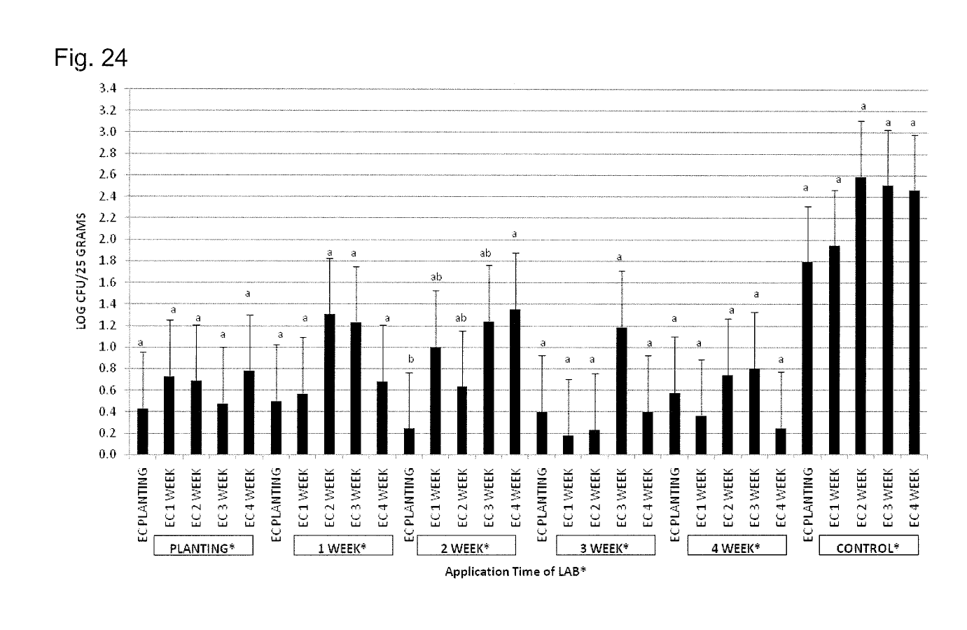

FIG. 23 describes the total numbers (log CFU/25-g) of E. coli O157:H7 recovered at harvest time on the soil sample, which included 25 grams (g) of top soil, when Lactiguard™ is electrostatically applied at one of the specific time points during the growing cycle. The figure is divided by the week/time point at which the E. coli O157:H7 was watered onto the plant and soil at a final concentration of 10³ CFU/ml. The “controls” in this group is plants that received E. coli O157:H7 at one of the specific time points during the growing cycle, but did not receive an application of Lactiguard™.

Within the soil samples (FIG. 23), when Escherichia coli O157:H7 contaminates the spinach plant at anytime between planting and the fourth week of the growing cycle and Lactiguard™ was electrostatically applied within the same time period, the E. coli O157:H7 numbers are significantly lower than the control plants that did not receive Lactiguard™ (P<0.05).

When E. coli O157:H7 contaminated the spinach plant at 10³ CFU/ml during planting with no intervention (control), at harvest 1.8 LOG CFU/25-g remained in the soil. When Lactiguard™ was applied electrostatically to the spinach plant between planting and the fourth week of the growing cycle when the E. coli O157:H7 was applied at planting, between 0.2-0.6 log CFU/25-g remained in the soil at harvest. These numbers indicated that a 1.3-1.6 log CFU/25-g reduction in E. coli O157:H7 is expected when compared to the control (P<0.05). There was no significant difference in the amount of E. coli O157:H7 recovered in the soil at harvest when E. coli O157:H7 was applied at planting and Lactiguard™ was applied electrostatically anytime between planting and the fourth week of the growing cycle (P>0.05).

Plants contaminated with E. coli O157:H7 at 10³ CFU/ml at 1 week post planting with no intervention (control), retained 1.9 log CFU/25-g in the soil at harvest. When Lactiguard™ was applied electrostatically to the spinach plant between planting and the fourth week of the growing cycle when the E. coli O157:H7 was applied at 1 week post planting, between 0.2-1.0 log CFU/25-g remained in the soil. These numbers indicated that a 0.9-1.7 log CFU/25-g reduction in E. coli O157:H7 is expected when compared to the control (P<0.05). There was no significant difference in the amount of E. coli O157:H7 recovered in the soil at harvest when E. coli O157:H7 was applied at 1 week post planting and Lactiguard™ was applied electrostatically at planting, 1 week, 3 weeks, and 4 weeks post planting (P>0.05). There was no significant difference in the amount of E. coli O157:H7 recovered in the soil at harvest when E. coli O157:H7 was applied at 1 week post planting between the control and when Lactiguard™ was applied electrostatically at 2 weeks post planting (P>0.05).

Plants contaminated with E. coli O157:H7 at 10³ CFU/ml at 2 weeks post planting with no intervention (control), retained 2.6 log CFU/25-g in the soil at harvest. When Lactiguard™ was applied electrostatically to the spinach plant between planting and the fourth week of the growing cycle when the E. coli O157:H7 was applied at 2 weeks post planting, between 0.2-1.3 log CFU/25-g remained in the soil. These numbers indicated that a 1.3-2.4 log CFU/25-g reduction in E. coli O157:H7 is expected when compared to the control (P<0.05). There was no significant difference in the amount of E. coli O157:H7 recovered in the soil at harvest when E. coli O157:H7 was applied at 2 weeks posts planting and Lactiguard™ was applied electrostatically at planting, 2 weeks, 3 weeks, and 4 weeks post planting (P>0.05). There was no significant difference in the amount of E. coli O157:H7 recovered in the soil at harvest when E. coli O157:H7 was applied at 2 weeks post planting and Lactiguard™ was applied electrostatically at planting, 1 week, 2 weeks and 4 weeks post planting (P>0.05).

Plants contaminated with E. coli O157:H7 at 10³ CFU/ml at 3 weeks post planting with no intervention (control), retained 2.5 log CFU/25-g in the soil at harvest. When Lactiguard™ was applied electrostatically to the spinach plant between planting and the fourth week of the growing cycle when the E. coli O157:H7 was applied at 3 weeks post planting, between 0.5-1.2 log CFU/25-g remained in the soil. These numbers indicated that a 1.3-2.0 log CFU/25-g reduction in E. coli O157:H7 is expected when compared to the control (P<0.05). There was no significant difference in the amount of E. coli O157:H7 recovered in the soil at harvest when E. coli O157:H7 was applied at 3 weeks post planting and Lactiguard™ was applied electrostatically anytime between planting and the fourth week of the growing cycle (P>0.05).

Plants contaminated with E. coli O157:H7 at 10³ CFU/ml at 4 weeks post planting with no intervention (control), retained 2.5 log CFU/25-g in the soil at harvest. When Lactiguard™ was applied electrostatically to the spinach plant between planting and the fourth week of the growing cycle when the E. coli O157:H7 was applied at 4 weeks post planting, between 0.3-1.4 log CFU/25-g remained in the soil. These numbers indicated that a 1.1-2.2 log CFU/25-g reduction in E. coli O157:H7 is expected when compared to the control (P<0.05). There was no significant difference in the amount of E. coli O157:H7 recovered in the soil at harvest when E. coli O157:H7 was applied at 4 weeks post planting and Lactiguard™ was applied electrostatically at planting, 1 week, and 2 weeks post planting (P>0.05). There was no significant difference in the amount of E. coli O157:H7 recovered in the soil at harvest when E. coli O157:H7 was applied at 4 weeks post planting and Lactiguard™ was applied electrostatically at planting, 1 week, 3 weeks and 4 weeks post planting (P>0.05).

FIG. 24 describes the total numbers (log CFU/25-g) of E. coli O157:H7 recovered at harvest time on soil sample, which included 25-grams of top soil, when Lactiguard™ is applied at one of the specific time points during the growing cycle. The figure is divided by the week/time point at which the Lactiguard™ was electrostatically applied onto the plant and soil at a final concentration of 10¹⁰ CFU/ml. The “controls” in this group is plants that received E. coli O157:H7 at one of the specific time points during the growing cycle, but did not receive the Lactiguard™.

When Lactiguard™ was electrostatically applied to the spinach plant during planting at 10¹⁰ CFU/ml and E. coli O157:H7 contaminated the plant between planting and the fourth week of the growing cycle, the recovered E. coli O157:H7 numbers at harvest on the soil samples were between 0.4-0.7 log CFU/25-g. There was no significant difference in the amount of E. coli O157:H7 recovered in the soil when Lactiguard™ was electrostatically applied to the spinach plant during the planting, when E. coli O157:H7 was applied anytime during the first four weeks of the growing cycle (P>0.05).

When Lactiguard™ was electrostatically applied to the spinach plant at 1 week post planting at 10¹⁰ CFU/ml and E. coli O157:H7 contaminated the plant between planting and the fourth week of the growing cycle, the recovered E. coli O157:H7 at harvest on the soil samples was between 0.5-1.3 log CFU/25-g. There was no significant difference in the amount of E. coli O157:H7 recovered in the soil at harvest when Lactiguard™ was electrostatically applied to the spinach plant at 1 week post planting, when E. coli O157:H7 was applied anytime between planting and the fourth weeks of the growing cycle (P>0.05).

When Lactiguard™ was electrostatically applied to the spinach plant at 2 weeks post planting at 10¹⁰ CFU/ml and E. coli O157:H7 contaminated the plant between planting and the fourth week of the growing cycle, the recovered E. coli O157:H7 at harvest on the soil samples was between 0.2-1.4 log CFU/25-g. There was no significant difference in the amount of E. coli O157:H7 recovered in the soil at harvest when Lactiguard™ was electrostatically applied to the spinach plant at 2 weeks post planting, when E. coli O157:H7 was applied between the first and third week of the growing cycle (P>0.05). There was no significant difference in the amount of E. coli O157:H7 recovered in the soil at harvest when Lactiguard™ was electrostatically applied to the spinach plant at 2 weeks post planting, when E. coli O157:H7 was applied between the first and fourth week of the growing cycle (P>0.05).

When Lactiguard™ was electrostatically applied to the spinach plant at 3 weeks post planting at 10¹⁰ CFU/ml and E. coli O157:H7 contaminated the plant between planting and the fourth week of the growing cycle, the recovered E. coli O157:H7 at harvest on the soil samples was between 0.2-1.2 log CFU/25-g. There was no significant difference in the amount of E. coli O157:H7 recovered in the soil at harvest when Lactiguard™ was electrostatically applied to the spinach plant at 3 weeks post planting, when E. coli O157:H7 was applied anytime between planting and the fourth week of the growing cycle (P>0.05).

When Lactiguard™ was electrostatically applied to the spinach plant at 4 weeks post planting at 10¹⁰ CFU/ml and E. coli O157:H7 contaminated the plant between planting and the fourth week of the growing cycle, the recovered E. coli O157:H7 at harvest on the soil samples were between 0.3-0.6 log CFU/25-g. There was no significant difference in the amount of E. coli O157:H7 recovered in the soil at harvest when Lactiguard™ was electrostatically applied to the spinach plant at 4 weeks post planting, when E. coli O157:H7 was applied anytime between planting and the fourth week of the growing cycle (P>0.05).

When Lactiguard™ was not applied to the spinach plant and E. coli O157:H7 contaminated the plant between planting and the fourth week of the growing cycle, the recovered E. coli O157:H7 at harvest in the soil samples were between 1.8-2.5 log CFU/25-g. There was no significant difference in the amount of E. coli O157:H7 recovered in the soil between planting and the fourth week of the growing cycle (P>0.05).

### Lactic Acid Bacteria Recovery at Harvest

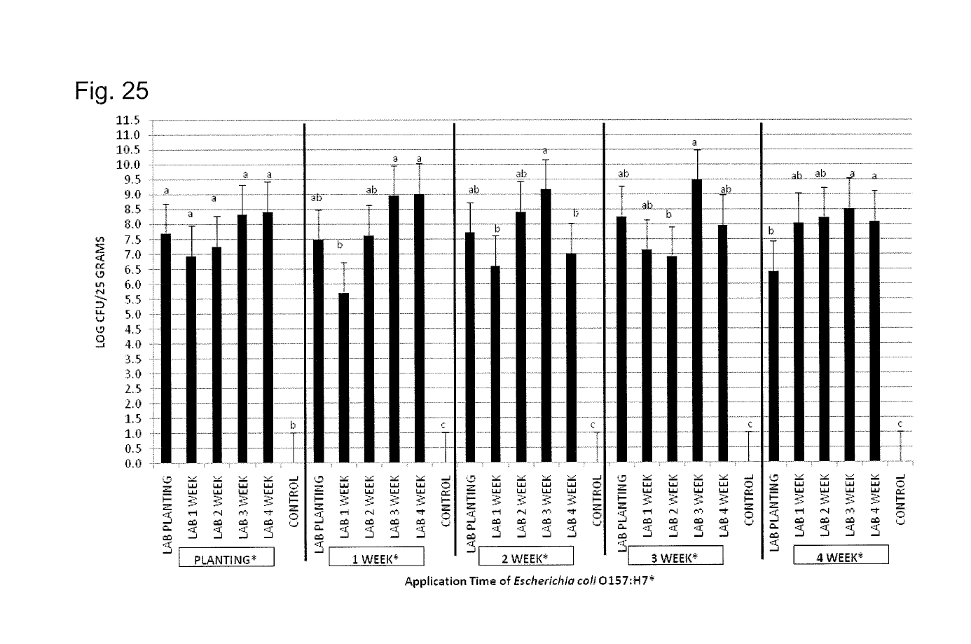

FIG. 25 describes the total numbers (log CFU/25-g) of lactic acid bacteria recovered at harvest time in the soil sample, which consists of 25-grams of top soil, when E. coli O157:H7 is applied at one of the specific time points during the growing cycle. The figure is divided by the week/time point at which the E. coli O157:H7 was watered onto the plant and soil at a final concentration of 10³ CFU/ml. The “controls” in this group is plants that received E. coli O157:H7 at one of the specific time points during the growing cycle, but did not receive an application of Lactiguard™.

When E. coli O157:H7 contaminated the spinach plant at 10³ CFU/ml during planting, the lactic acid bacteria remained between 6.9-8.4 log CFU/25-g at harvest in the soil when Lactiguard™ was electrostatically applied between planting and the fourth week of the growing cycle (FIG. 25). There was no significant difference in the amount of lactic acid bacteria recovered in the soil at harvest when E. coli O157:H7 was applied at planting and Lactiguard™ was applied electrostatically between planting and fourth week of the growing cycle (P>0.05).

When E. coli O157:H7 contaminated the spinach plant at 10³ CFU/ml at 1 week post planting, the lactic acid bacteria remained between 5.7-9.0 log CFU/25-g at harvest in the soil when Lactiguard™ was electrostatically applied between planting and the fourth week of the growing cycle (FIG. 25). There was no significant difference in the amount of lactic acid bacteria recovered in the soil at harvest when E. coli O157:H7 was applied at 1 week post planting and Lactiguard™ was applied electrostatically at planting, 1 week, and 2 weeks post planting (P>0.05). There was no significant difference in the amount of lactic acid bacteria recovered in the soil at harvest when E. coli O157:H7 was applied at 1 week post planting and Lactiguard™ was applied electrostatically at planting, 2 weeks, 3 weeks and 4 weeks post planting (P>0.05).

When E. coli O157:H7 contaminated the spinach plant at 10³ CFU/ml at 2 weeks post planting, the lactic acid bacteria remained between 7.0-9.2 log CFU/25-g at harvest in the soil when Lactiguard™ was electrostatically applied between planting and the fourth week of the growing cycle (FIG. 25). There was no significant difference in the amount of lactic acid bacteria recovered in the soil at harvest when E. coli O157:H7 was applied at 2 weeks post planting and Lactiguard™ was applied electrostatically at planting, 1 week, 2 weeks, and 4 weeks post planting (P>0.05). There was no significant difference in the amount of lactic acid bacteria recovered in the soil at harvest when E. coli O157:H7 was applied at 2 weeks post planting and Lactiguard™ was applied electrostatically at planting, 2 weeks, and 3 weeks post planting (P>0.05).

When E. coli O157:H7 contaminated the spinach plant at 10³ CFU/ml at 3 weeks post planting, the lactic acid bacteria remained between 6.9-9.5 log CFU/25-g at harvest in the soil when Lactiguard™ was electrostatically applied between planting and the fourth week of the growing cycle (FIG. 25). There was no significant difference in the amount of lactic acid bacteria recovered in the soil at harvest when E. coli O157:H7 was applied at 3 weeks post planting and Lactiguard™ was applied electrostatically at planting, 1 week, 2 weeks, and 4 weeks post planting (P>0.05). There was no significant difference in the amount of lactic acid bacteria recovered in the soil at harvest when E. coli O157:H7 was applied at 3 weeks post planting and Lactiguard™ was applied electrostatically at planting, 1 week, 2 weeks, and 4 weeks post planting (P>0.05).

When E. coli O157:H7 contaminated the spinach plant at 10³ CFU/ml at 4 weeks post planting, the lactic acid bacteria remained between 6.4-8.5 log CFU/25-g at harvest in the soil when Lactiguard™ was electrostatically applied between planting and the fourth week of the growing cycle (FIG. 25). There was no significant difference in the amount of lactic acid bacteria recovered in the soil at harvest when E. coli O157:H7 was applied at 4 weeks post planting and Lactiguard™ was applied electrostatically at planting , 1 week and 2 weeks post planting (P>0.05). There was no significant difference in the amount of lactic acid bacteria recovered in the soil at harvest when E. coli O157:H7 was applied at 4 weeks post planting and Lactiguard™ was applied electrostatically between the first and fourth weeks of the growing cycle (P>0.05).

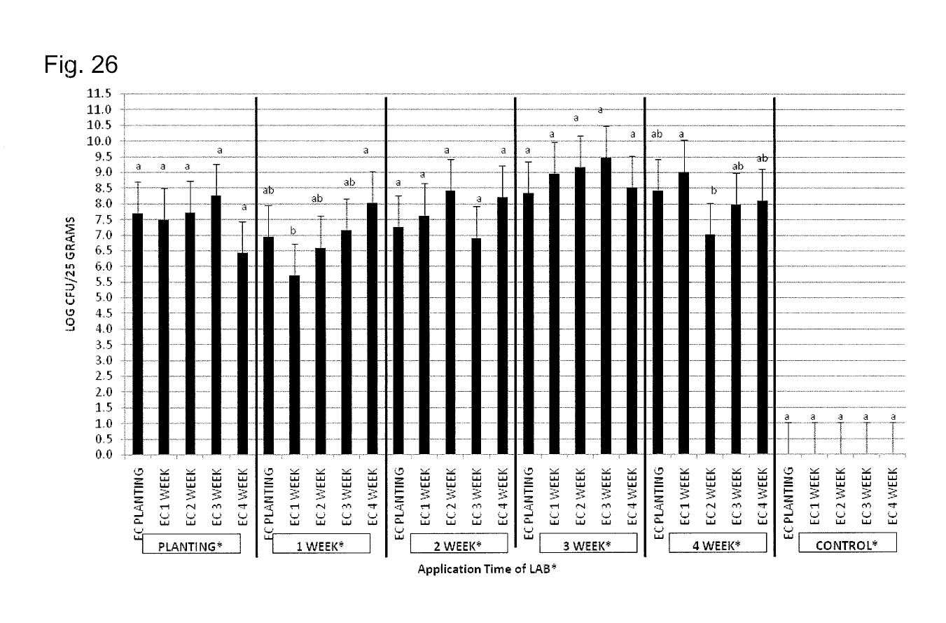

FIG. 26 describes the total numbers (log CFU/25-g) of lactic acid bacteria recovered at harvest time in the soil sample, which consists of 25-g of top soil, when E. coli O157:H7 is applied at one of the specific time points during the growing cycle. The figure is divided by the week/time point at which the Lactiguard™ was electrostatically applied onto the plant and/or soil at a final concentration of 10¹⁰ CFU/ml. The “controls” in this group is plants that received E. coli O157:H7 at one of the specific time points during the growing cycle, but did not receive an application of Lactiguard™.

There were several significant differences between the samples, but in general all the samples, regardless of E. coli O157:H7 time of contamination or the time point Lactiguard™ was electrostatically applied to the spinach plant, there was between 6.4-9.5 log CFU/25-g of LAB recovered in the soil at harvest (P at 0.05).

### Entire Plant Samples

E. coli O157:H7 Recovery at Harvest

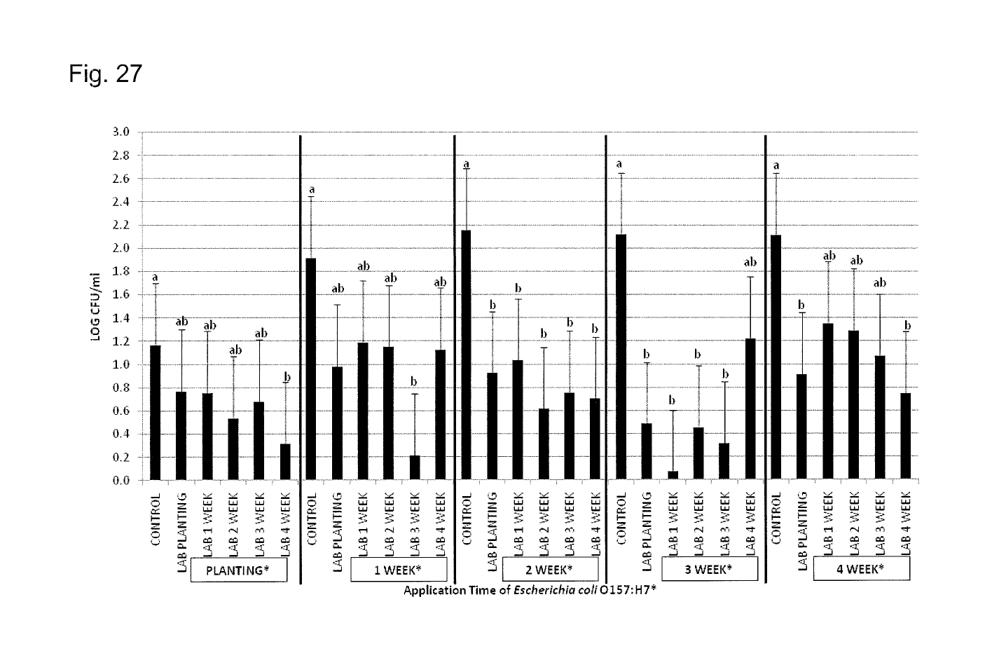

FIG. 27 describes the total numbers (log CFU/ml) of E. coli O157:H7 recovered at harvest time from the entire plant samples, which consists of 4 entire plants including all leaves, stems, roots, and attached soil, when Lactiguard™ is electrostatically applied at one of the specific time points during the growing cycle. The figure is divided by the week/time point at which the E. coli O157:H7 was watered onto the plant and soil at a final concentration of 103 CFU/ml. The “controls” in this group is plants that received E. coli O157:H7 at one of the specific time points during the growing cycle, but did not receive an application of Lactiguard™.

Within the entire plant samples (FIG. 27), there are no clear trends among all the comparisons between the control group and those receiving Lactiguard™. Therefore, it is important to breakdown the data and discuss it based on the specific application time period.

When E. coli O157:H7 contaminated the spinach plant at 10³ CFU/ml during planting with no intervention (control), at harvest 1.2 log CFU/ml remained on the entire plant. When Lactiguard™ was applied electrostatically to the spinach plant between planting and the fourth week of the growing cycle when the E. coli O157:H7 was applied at planting, between 0.3-0.8 log CFU/ml remained on the entire plant. These numbers indicated that a 0.4-0.9 log CFU/ml reduction in E. coli O157:H7 is expected when compared to the control plants (P<0.05). There was no significant difference in the amount of E. coli O157:H7 recovered on the entire plant at harvest when E. coli O157:H7 was applied at planting and Lactiguard™ was applied electrostatically anytime between planting and the fourth weeks of the growing cycle (P>0.05). There was no significant difference in the amount of E. coli O157:H7 recovered on the entire plant at harvest when E. coli O157:H7 was applied at planting and Lactiguard™ was applied electrostatically at planting, 1 week, 2 weeks, and 3 weeks post planting and with the control plants that did not receive Lactiguard™ (P>0.05).

Plants contaminated with E. coli O157:H7 at 10³ CFU/ml at 1 week post planting with no intervention (control), retained 1.9 logs CFU/ml on the entire plant at harvest. When Lactiguard™ was applied electrostatically to the spinach plant between planting and the fourth week of the growing cycle when the E. coli O157:H7 was applied at 1 week post planting, between 0.2-1.2 log CFU/ml remained on the entire plant. These numbers indicated that a 0.8-1.7 log CFU/ml reduction in E. coli O157:H7 is expected when compared to the control plants (P<0.05). There was no significant difference in the amount of E. coli O157:H7 recovered on the entire plant at harvest when E. coli O157:H7 was applied at 1 week post planting and Lactiguard™ was applied electrostatically anytime between planting and the fourth week of the growing cycle (P>0.05). There was no significant difference in the amount of E. coli O157:H7 recovered on the entire plant at harvest when E. coli O157:H7 was applied at 1 week post planting between the control plants and those that received electrostatically applied Lactiguard™ at planting, 1 week, 2 weeks, and 4 weeks post planting and with the control plants that did not receive Lactiguard™ (P>0.05).

Plants contaminated with E. coli O157:H7 at 10³ CFU/ml at 2 weeks post planting with no intervention (control), retained 2.2 log CFU/ml on the entire plant at harvest. When Lactiguard™ was applied electrostatically to the spinach plant between planting and the fourth week of the growing cycle when the E. coli O157:H7 was applied at 2 weeks post planting, between 0.6-1.0 log CFU/ml remained on the entire plant. These numbers indicated that a 1.2-1.6 log CFU/ml reduction in E. coli O157:H7 is expected when compared to the control plants (P<0.05). There was no significant difference in the amount of E. coli O157:H7 recovered on the entire plant at harvest when E. coli O157:H7 was applied at 2 weeks posts planting and Lactiguard™ was applied anytime electrostatically between planting and the fourth week of the growing cycle (P>0.05).

Plants contaminated with E. coli O157:H7 at 10³ CFU/ml at 3 weeks post planting with no intervention (control), retained 2.1 log CFU/ml on the entire plant at harvest. When Lactiguard™ was applied electrostatically to the spinach plant between planting and the fourth week of the growing cycle when the E. coli O157:H7 was applied at 3 weeks post planting, between 0.3-1.2 log CFU/ml remained on the entire plant. These numbers indicated that a 0.9-2.0 log CFU/ml reduction in E. coli O157:H7 is expected when compared to the control plants (P<0.05). There was no significant difference in the amount of E. coli O157:H7 recovered on the entire plant at harvest when E. coli O157:H7 was applied at 3 weeks post planting and Lactiguard™ was applied electrostatically anytime between planting and the fourth week of the growing cycle (P>0.05). There was no significant difference in the amount of E. coli O157:H7 recovered on the entire plant at harvest when E. coli O157:H7 was applied at 3 weeks post planting and Lactiguard™ was applied electrostatically at 4 weeks post planting and with the control plants that did not receive Lactiguard™ (P>0.05).

Plants contaminated with E. coli O157:H7 at 10³ CFU/ml at 4 weeks post planting with no intervention (control), retained 2.1 log CFU/ml on the entire plant at harvest. When Lactiguard™ was applied electrostatically to the spinach plant between planting and the fourth week of the growing cycle when the E. coli O157:H7 was applied at 4 weeks post planting, between 0.7-1.4 log CFU/ml remained on the entire plant. These numbers indicated that a 0.7-1.4 log CFU/ml reduction in E. coli O157:H7 is expected when compared to the control plants (P<0.05). There was no significant difference in the amount of E. coli O157:H7 recovered on the entire plant at harvest when E. coli O157:H7 was applied at 4 weeks post planting and Lactiguard™ was applied electrostatically anytime between planting and the fourth week of the growing cycle (P>0.05). There was no significant difference in the amount of E. coli O157:H7 recovered on the entire plant at harvest when E. coli O157:H7 was applied at 4 weeks post planting and Lactiguard™ was applied electrostatically at 1 week, 2 weeks, and 3 weeks post planting and with the control plants that did not receive Lactiguard™ (P>0.05).

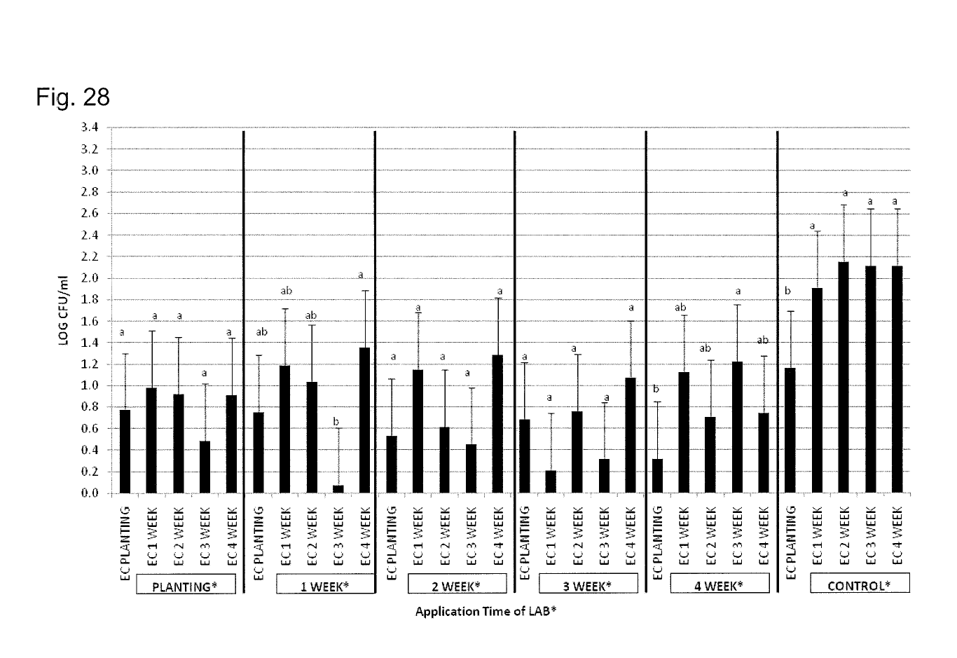

FIG. 28 describes the total numbers (log CFU/ml) of E. coli O157:H7 recovered at harvest time in the entire plant samples, which consists of 4 entire plants including all leaves, stems, roots, and attached soil, when Lactiguard™ is applied at one of the specific time points during the growing cycle. The figure is divided by the week/time point at which the Lactiguard™ was electrostatically applied onto the plant and soil at a final concentration of 10¹⁰ CFU/ml. The “controls” in this group is plants that received E. coli O157:H7 at one of the specific time points during the growing cycle, but did not receive an application of Lactiguard™.

When Lactiguard™ was electrostatically applied to the spinach plant during the planting at 10¹⁰ CFU/ml and E. coli O157:H7 contaminated the plant between planting and the fourth week of the growing cycle, the recovered E. coli O157:H7 at harvest on the entire plant samples were between 0.5-1.0 log CFU/ml. There was no significant difference in the amount of E. coli O157:H7 recovered on the entire plant at harvest when Lactiguard™ was electrostatically applied to the spinach plant during the planting and when E. coli O157:H7 was applied anytime between planting and the fourth week of the growing cycle (P>0.05).

When Lactiguard™ was electrostatically applied to the spinach plant at 1 week post planting at 10¹⁰ CFU/ml and E. coli O157:H7 contaminated the plant between planting and the fourth week of the growing cycle, the recovered E. coli O157:H7 at harvest on the entire plant samples were between 0.1-1.4 log CFU/ml. There was no significant difference in the amount of E. coli O157:H7 recovered on the entire plant at harvest when Lactiguard™ was electrostatically applied to the spinach plant at 1 week post planting and when E. coli O157:H7 was applied at planting, 1 week, 2 weeks, and 3 weeks post planting (P>0.05). There was no significant difference in the amount of E. coli O157:H7 recovered on the entire plant at harvest when Lactiguard™ was electrostatically applied to the spinach plant at 1 week post planting and when E. coli O157:H7 was applied at planting, 1 week, 2 weeks, and 4 weeks post planting (P>0.05).

When Lactiguard™ was electrostatically applied to the spinach plant at 2 weeks post planting at 10¹⁰ CFU/ml and E. coli O157:H7 contaminated the plant between planting and the fourth week of the growing cycle, the recovered E. coli O157:H7 at harvest on the entire plant samples were between 0.4-1.3 log CFU/ml. There was no significant difference in the amount of E. coli O157:H7 recovered on the entire plant at harvest when Lactiguard™ was electrostatically applied to the spinach plant at 2 week post planting and when E. coli O157:H7 was applied anytime between planting and the fourth weeks of the growing cycle (P>0.05).

When Lactiguard™ was electrostatically applied to the spinach plant at 3 weeks post planting at 10¹⁰ CFU/ml and E. coli O157:H7 contaminated the plant between planting and the fourth week of the growing cycle, the recovered E. coli O157:H7 at harvest on the entire plant samples were between 0.2-1.1 log CFU/ml. There was no significant difference in the amount of E. coli O157:H7 recovered on the entire plant at harvest when Lactiguard™ was electrostatically applied to the spinach plant at 3 weeks post planting and when E. coli O157:H7 was applied anytime between planting and the fourth week of the growing cycle (P>0.05).

When Lactiguard™ was electrostatically applied to the spinach plant at 4 weeks post planting at 10¹⁰ CFU/ml and E. coli O157:H7 contaminated the plant between planting and the fourth week of the growing cycle, the recovered E. coli O157:H7 at harvest on the entire plant samples were between 0.3-1.2 log CFU/ml. There was no significant difference in the amount of E. coli O157:H7 recovered on the entire plant at harvest when Lactiguard™ was electrostatically applied to the spinach plant at 4 weeks post planting and when E. coli O157:H7 was applied at planting, 1 week, 2 weeks, and 4 weeks post planting (P>0.05). There was no significant difference in the amount of E. coli O157:H7 recovered on the entire plant at harvest when Lactiguard™ was electrostatically applied to the spinach plant at 4 weeks post planting and when E. coli O157:H7 was applied at 1 week, 2 weeks, 4 weeks and 4 weeks post planting (P>0.05).

When Lactiguard™ was not applied to the spinach plant and E. coli O157:H7 contaminated the plant between planting and the fourth week of the growing cycle, the recovered E. coli O157:H7 at harvest on the entire plant samples were between 1.2-2.2 log CFU/ml. There was no significant difference in the amount of E. coli O157:H7 recovered on the entire plant at 1 week, 2 weeks, 3 weeks, and 4 weeks post planting (P>0.05). There were a significantly lower amount of E. coli O157:H7 recovered on the entire plant at planting when compared to those on 1 week, 2 weeks, 3 weeks, and 4 weeks post planting at harvest (P<0.05).

### Lactic Acid Bacteria Recovery at Harvest

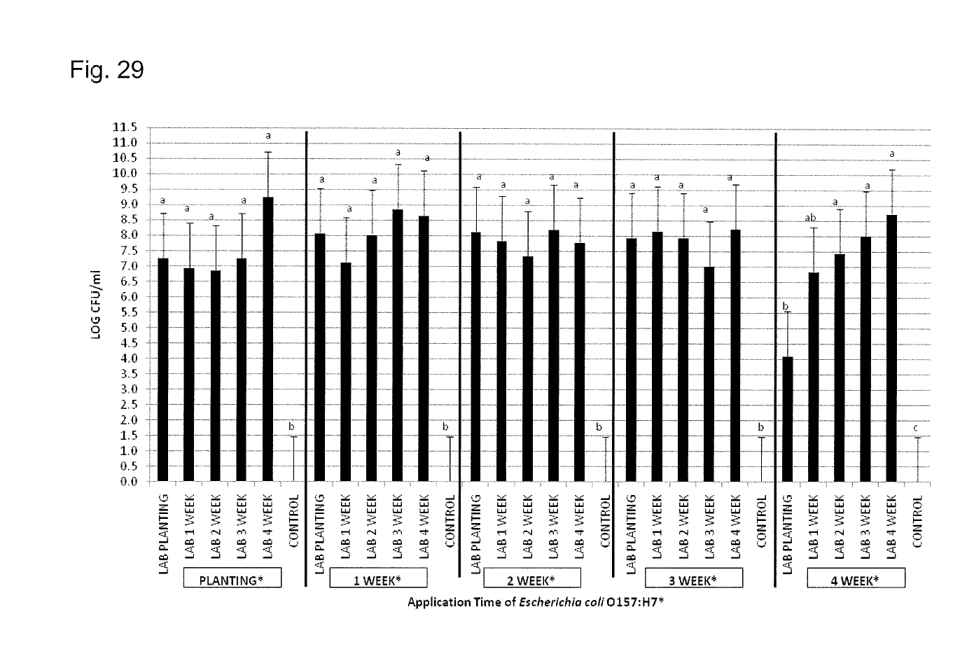

FIG. 29 describes the total numbers (log CFU/ml) of lactic acid bacteria recovered at harvest time on the entire plant sample, which consists of 4 entire plants including all leaves, stems, roots, and attached soil, when E. coli O157:H7 is applied at one of the specific time points during the growing cycle. The figure is divided by the week/time point at which the E. coli O157:H7 was watered onto the plant and soil at a final concentration of 10³ CFU/ml. The “controls” in this group is plants that received E. coli O157:H7 at one of the specific time points during the growing cycle, but did not receive an application of Lactiguard™.

When E. coli O157:H7 contaminated the spinach plant at 10³ CFU/ml during planting, the lactic acid bacteria remained between 6.9-9.3 log CFU/ml at harvest on the entire plant when Lactiguard™ was electrostatically applied between planting and the fourth week of the growing cycle (FIG. 29). There was no significant difference in the amount of lactic acid bacteria recovered on the entire plant at harvest when E. coli O157:H7 was applied at planting and Lactiguard™ was applied electrostatically anytime between planting and the fourth week of the growing cycle (P>0.05). When E. coli O157:H7 contaminated the spinach plant at 10³ CFU/ml at 1 week post planting, the lactic acid bacteria remained between 7.1-8.9 log CFU/ml at harvest on the entire plant when Lactiguard™ was electrostatically applied between planting and the fourth week of the growing cycle (FIG. 29). There was no significant difference in the amount of lactic acid bacteria recovered on the entire plant at harvest when E. coli O157:H7 was applied at 1 week post planting and Lactiguard™ was applied electrostatically anytime between planting and the fourth week of the growing cycle (P>0.05).

When E. coli O157:H7 contaminated the spinach plant at 10³ CFU/ml at 2 weeks post planting, the lactic acid bacteria remained between 7.3-8.2 log CFU/ml at harvest on the entire plant when Lactiguard™ was electrostatically applied between planting and the fourth week of the growing cycle (FIG. 29). There was no significant difference in the amount of lactic acid bacteria recovered on the entire plant at harvest when E. coli O157:H7 was applied at 2 weeks post planting and Lactiguard™ was applied electrostatically anytime between planting and the fourth week of the growing cycle (P>0.05).

When E. coli O157:H7 contaminated the spinach plant at 10³ CFU/ml at 3 weeks post planting, the lactic acid bacteria remained between 7.0-8.2 log CFU/ml at harvest on the entire plant when Lactiguard™ was electrostatically applied between planting and the fourth week of the growing cycle (FIG. 29). There was no significant difference in the amount of lactic acid bacteria recovered on the entire plant at harvest when E. coli O157:H7 was applied at 3 weeks post planting and Lactiguard™ was applied electrostatically anytime between planting and the fourth week of the growing cycle (P>0.05).

When E. coli O157:H7 contaminated the spinach plant at 10³ CFU/ml at 4 weeks post planting, the lactic acid bacteria remained between 4.1-8.7 log CFU/ml at harvest on the entire plant when Lactiguard™ was electrostatically applied between planting and the fourth week of the growing cycle (FIG. 29). There was no significant difference in the amount of lactic acid bacteria recovered on the entire plant at harvest when E. coli O157:H7 was applied at 4 weeks post planting and Lactiguard™ was applied electrostatically between the first and fourth weeks post planting (P>0.05). There was no significant difference in the amount of lactic acid bacteria recovered on the entire plant at harvest when E. coli O157:H7 was applied at 4 weeks post planting and Lactiguard™ was applied electrostatically at planting and 1 week post planting (P>0.05).

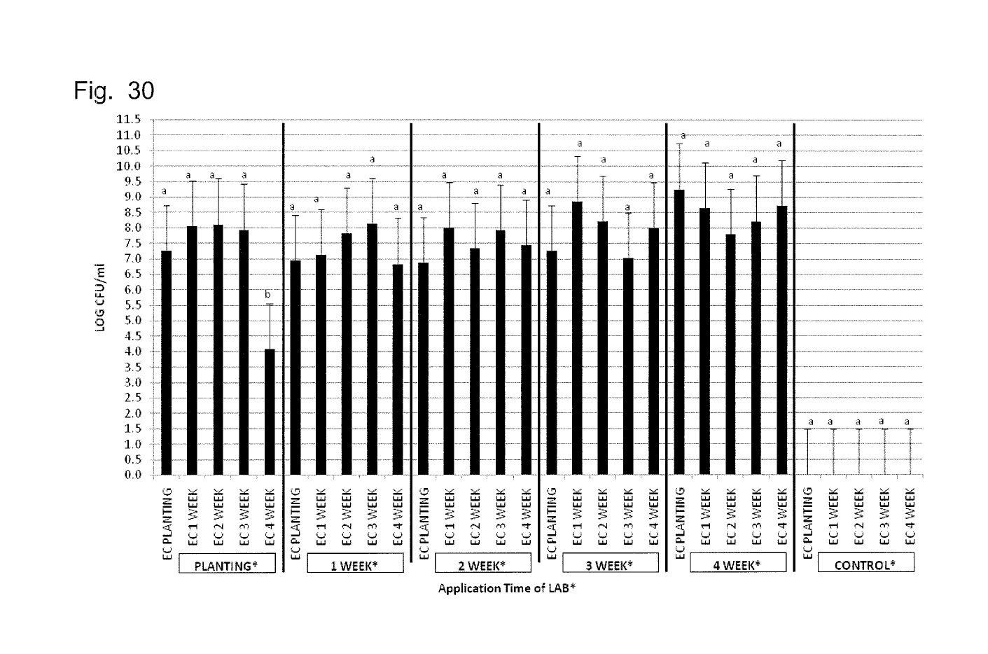

FIG. 30 describes the total numbers (log CFU/ml) of lactic acid bacteria recovered at harvest time in the entire plant sample, which consists of 4 entire plants including all leaves, stems, roots, and attached soil, when E. coli O157:H7 is applied at one of the specific time points during the growing cycle. The figure is divided by the week/time point at which the Lactiguard™ was electrostatically applied onto the plant and soil at a final concentration of 10¹⁰ CFU/ml. The “controls” in this group is plants that received E. coli O157:H7 at one of the specific time points during the growing cycle, but did not receive an application of Lactiguard™.

There was a low level of lactic acid bacteria reported (4.1 log CFU/ml) when E. coli O157:H7 was applied at 4 weeks post planting and Lactiguard™ was applied at planting. This created differences between plants that received Lactiguard™ at planting and E. coli O157:H7 at different time points. When this point is removed from the data set, there was no significant differences among the total numbers of lactic acid bacteria recovered on the entire type samples, regardless of E. coli O157:H7 time of contamination or the time point Lactiguard™ was electrostatically applied to the spinach plant (P>0.05). Overall, lactic acid bacteria were recovered on the entire plant samples between 6.8-9.3 log CFU/ml regardless of E. coli O157:H7 time of contamination or the time point Lactiguard™ was electrostatically applied to the spinach plant.

1. A method for reducing at least one pathogen in a plant material, said method comprising a step (a) of contacting said plant material with a composition in an amount effective for reducing the number of at least one pathogen in said plant material, said composition comprising at least one lactic acid producing microorganism.

2. The method of claim 1, wherein the pathogen is at least one member selected from the group consisting of E. coli O157:H7, Staphylococcus aureus, Listeria monocytogenes, Campylobacter jejuni, Clostridium botulinum, Clostridium sporogenes, and Salmonella typhimurium.

3. The method of claim 1, wherein the composition comprises at least one lactic acid producing microorganism selected from the group consisting of Lactobacillus acidophilus, Lactococcus lactis, Lactobacillus animalis, Lactobacillus crispatus and Pediococcus acidilactici.

4. The method of claim 1, wherein the composition comprises at least two species selected from the group consisting of Lactobacillus acidophilus, Lactococcus lactis, Lactobacillus animalis, Lactobacillus crispatus and Pediococcus acidilactici.

5. The method of claim 1, wherein the composition comprises at least four different species selected from the group consisting of Lactobacillus acidophilus, Lactococcus lactis, Lactobacillus animalis, Lactobacillus crispatus and Pediococcus acidilactici.

6. The method of claim 1, wherein the at least one lactic acid producing microorganism is at least one strain selected from the group consisting of NP 35, LA45, L411, NP 3 and NP 7.

7. The method of claim 1, wherein the composition comprises lactic acid bacterial strains NP 35, NP 3 and NP 7.

8. The method of claim 1, wherein said contacting step (a) occurs before harvest of said plant material.

9. The method of claim 1, wherein the contacting step is started before harvest of said plant material, and is completed after harvest of said plant material.

10. (canceled)

11. The method of claim 8, wherein said composition is sprayed electrostatically onto said plant material.

12. The method of claim 11, wherein said composition comprises at least one lactic acid producing bacterium at a concentration of between 5×10⁹ and 5×10¹¹ CFU per ml of said composition.

13. (canceled)

14. The method of claim 1, wherein said contacting step (a) occurs after harvest of said plant material.

15. The method of claim 14, wherein the composition comprises at least one lactic acid bacterium at a concentration of from about 5×10⁶ to about 5×10⁹ CFU per ml of said composition.

16-20. (canceled)

21. The method of claim 14, wherein said plant material is incubated with said composition during the contacting step (a) at a temperature of between 1-30° C. for at least 5 minutes.

22. (canceled)

23. The method of claim 14, wherein said plant material is incubated with an effective amount of said composition during the contacting step (a) at a temperature of between 2-10° C. for at least 8 hours, said effective amount being the amount effective for reducing by at least 2 the log₁₀ CFU of said at least one pathogen per gram of the plant material.

24. The method of claim 14, wherein said plant material is incubated with said composition during the contacting step (a) at a temperature of between 18-30° C. for at least 30 minutes.

25. The method of claim 14, wherein said plant material is incubated with an effective amount of said composition during the contacting step (a) at a temperature of about 25° C. for at least 8 hours, said effective amount being the amount effective for reducing by at least 2 the log₁₀ CFU of said at least one pathogen per gram of the plant material.

26. (canceled)

27. The method of claim 1, wherein the plant material is a member selected from the group consisting of fruit, vegetable, seed and combination thereof.

28. The method of claim 1, wherein the plant material is spinach.

29-36. (canceled)

37. A method for reducing at least one pathogen in a plant material, said method comprising a step (a) of contacting a said plant material with a composition in an amount effective for reducing the number of at least one pathogen in said plant material, said composition comprising the lactic acid bacterial strains NP 35, NP 3 and NP 7.

38. (canceled)
